(19) United States
(12) Patent Application Publication
(10) Pub. No.: US 2025/0132840 A1
(43) Pub. Date: Apr. 24, 2025

(54) STATE-OF-POLARIZATION MONITORING APPARATUS, STATE-OF-POLARIZATION MONITORING METHOD, AND NON-TRANSITORY COMPUTER-READABLE STORAGE MEDIUM

(71) Applicant: NEC Corporation, Tokyo (JP)

(72) Inventor: Mingqi WU, Tokyo (JP)

(73) Assignee: NEC Corporation, Tokyo (JP)

(21) Appl. No.: 18/898,923

(22) Filed: Sep. 27, 2024

(30) Foreign Application Priority Data
Oct. 18, 2023 (JP) 2023-179716

(51) Int. Cl. H04B 10/61; G01J 4/00; H04B 10/079

(52) U.S. Cl. CPC H04B 10/6166; G01J 4/00; H04B 10/0795

(57) ABSTRACT

A state-of-polarization monitoring apparatus performs: determining a first state-of-polarization (SOP) vector that represents an SOP of an optical reception signal in a the first partial period for each first partial period and a second SOP vector that represents an SOP of the optical reception signal in the second partial period for each second partial period; computing a rotation angle of the first SOP vector for each pair of first SOP vectors and a rotation angle of the second SOP vector for each pair of second SOP vectors; determining whether a length of the first partial period or a length of an interval between the first partial periods is appropriate based on the rotation angles of the first and second SOP vectors.

### INCORPORATION BY REFERENCE

This application is based upon and claims the benefit of priority from Japanese patent application No. 2023-179716, filed on Oct. 18, 2023, the disclosure of which is incorporated herein in its entirety by reference.

### TECHNICAL FIELD

The present disclosure relates to a state-of-polarization monitoring apparatus, a state-of-polarization monitoring method, and a non-transitory computer-readable storage medium.

### BACKGROUND ART

Technologies for monitoring a change in the state of polarization (SOP) of an optical signal in an optical communication system have been developed. For example, NPL1 discloses a technique for monitoring a change in the state of polarization of an optical reception signal that has been modulated by Quadrature Phase-Shift Keying (QPSK). A system disclosed in Non-patent Literature 1 computes a plurality of Jones vectors from an optical reception signal, and maps each of the computed Jones vectors to a point in a Stokes space. Next, the system disclosed in Non-patent Literature 1 divides the plurality of points obtained by the mapping into four groups, and computes the center point of each of the groups. Further, the system disclosed in NPL1 computes a normal vector based on the computed four center points. The system disclosed in NPL1 monitors the state of polarization of the optical reception signal based on the rotation speed of the normal vector computed as described above.

### CITATION LIST

### Non Patent Literature

NPL1: Jingnan Li, Yangyang Fan, Zhenning Tao, Hisao Nakashima, and Takeshi Hoshida, “Polarization Change Monitor Based on Geometrical Analysis in Stokes Space”, 2021 European Conference on Optical Communication (ECOC), Nov. 22, 2021
NPL2: Bogdan Szafraniec, Todd S. Marshall, and Bernd Nebendahl, “Performance Monitoring and Measurement Techniques for Coherent Optical Systems”, Journal of Lightwave Technology, Feb. 15, 2013, vol. 31, no. 4, pp. 648-663

### SUMMARY

In a first example aspect, a state-of-polarization monitoring apparatus comprises: at least one memory that is configured store instructions; and at least one processor that is configured to execute the instructions to: determining, for each of a plurality of first partial periods obtained from a monitoring period, a first state-of-polarization vector that represents a state of polarization of an optical reception signal in the first partial period; determining, for each of a plurality of second partial periods obtained from the monitoring period, a second state-of-polarization vector that represents a state of polarization of the optical reception signal in the second partial period; computing, for each of a plurality of pairs of first state-of-polarization vectors, a rotation angle of the first state-of-polarization vector; computing, for each of a plurality of pairs of second state-of-polarization vectors, a rotation angle of the second state-of-polarization vector; determining whether a length of the first partial period or a length of an interval between the first partial periods is appropriate or not based on the rotation angles of the first state-of-polarization vectors and the rotation angles of the second state-of-polarization vectors; and outputting, when it is determined that the length of the first partial period or the length of the interval between the first partial periods is appropriate, changing rate data that represents a changing rate of the state of polarization in the monitoring period based on the rotation angle of the first state-of-polarization vector. A length of the second partial period is shorter than the length of the first partial period, or a length of an interval between the second partial periods is shorter than the length of the interval between the first partial periods.

In a second example aspect, a state-of-polarization monitoring method performed by a computer comprises: determining, for each of a plurality of first partial periods obtained from a monitoring period, a first state-of-polarization vector that represents a state of polarization of an optical reception signal in the first partial period; determining, for each of a plurality of second partial periods obtained from the monitoring period, a second state-of-polarization vector that represents a state of polarization of an optical reception signal in the second partial period; computing, for each of a plurality of pairs of first state-of-polarization vectors, a rotation angle of the first state-of-polarization vector; computing, for each of a plurality of pairs of second state-of-polarization vectors, a rotation angle of the second state-of-polarization vector; determining whether a length of the first partial period or a length of an interval between first partial periods is appropriate or not based on the rotation angles of the first state-of-polarization vectors and the rotation angles of the second state-of-polarization vectors; and outputting, when it is determined that the length of the first partial period or the length of the interval between the first partial periods is appropriate, changing rate data that represents a changing rate of the state of polarization in the monitoring period based on the rotation angle of the first state-of-polarization vector. A length of the second partial period is shorter than the length of the first partial period, or a length of an interval between the second partial periods is shorter than the length of the interval between the first partial periods.

In a third example aspect, a non-transitory computer-readable medium storing a program that causes a computer to execute: determining, for each of a plurality of first partial periods obtained from a monitoring period, a first state-of-polarization vector that represents a state of polarization of an optical reception signal in the first partial period; determining, for each of a plurality of second partial periods obtained from the monitoring period, a second state-of-polarization vector that represents a state of polarization of an optical reception signal in the second partial period; computing, for each of a plurality of pairs of first state-of-polarization vectors, a rotation angle of the first state-of-polarization vector; computing, for each of a plurality of pairs of second state-of-polarization vectors, a rotation angle of the second state-of-polarization vector; determining whether a length of the first partial period or a length of an interval between first partial periods is appropriate or not based on the rotation angles of the first state-of-polarization vectors and the rotation angles of the second state-of-polarization vectors; and outputting, when it is determined that the length of the first partial period or the length of the interval between the first partial periods is appropriate, changing rate data that represents a changing rate of the state of polarization in the monitoring period based on the rotation angle of the first state-of-polarization vector. A length of the second partial period is shorter than the length of the first partial period, or a length of an interval between the second partial periods is shorter than the length of the interval between the first partial periods.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 shows an example of an optical transceiver system to which a state-of-polarization monitoring apparatus according to an aspect of the present disclosure is applied;

FIG. 2 shows an example of an overview of operations performed by a state-of-polarization monitoring apparatus;

FIG. 3 shows an example of aliasing related to the rotation angle of a state of polarization;

FIG. 4 is a first block diagram showing an example of a functional configuration of the state-of-polarization monitoring apparatus;

FIG. 5 shows a block diagram showing an example of a hardware configuration of a computer for implementing the state-of-polarization monitoring apparatus;

FIG. 6 shows a first flowchart showing an example of a flow of processes performed by a state-of-polarization monitoring apparatus;

FIG. 7 shows a situation where the length of the interval between first partial periods and the length of the interval between second partial periods differ from each other;

FIG. 8 shows a second block diagram showing an example of a functional configuration of a state-of-polarization monitoring apparatus;

FIG. 9 shows a second flowchart showing an example of a flow of processes performed by a state-of-polarization monitoring apparatus;

FIG. 10 shows a third flowchart showing an example of a flow of processes performed by a state-of-polarization monitoring apparatus;

FIG. 11 shows an example of a first partial period, a second partial period, and a third partial period;

FIG. 12 shows a fourth flowchart showing an example of a flow of processes performed by a state-of-polarization monitoring apparatus;

FIG. 13 shows the fourth flowchart showing the example of the flow of processes performed by the state-of-polarization monitoring apparatus;

FIG. 14 shows a fifth flowchart showing an example of a flow of processes performed by a state-of-polarization monitoring apparatus; and

FIG. 15 shows the fifth flowchart showing the example of the flow of processes performed by the state-of-polarization monitoring apparatus.

### EXAMPLE EMBODIMENT

An example embodiment according to the present disclosure will be described in detail hereinafter with reference to the drawings. The same or corresponding elements are assigned the same reference numerals (or symbols) throughout the drawings, and redundant descriptions thereof will be omitted as appropriate for clarifying the explanation. Further, unless otherwise described, pre-defined value such as predetermined values and thresholds are stored in advance in a storage device or the like accessible from an apparatus that uses these values. Further, unless otherwise described, the storage unit is formed by one or an arbitrary number of storage devices.

### First Example Embodiment

### <Overview>

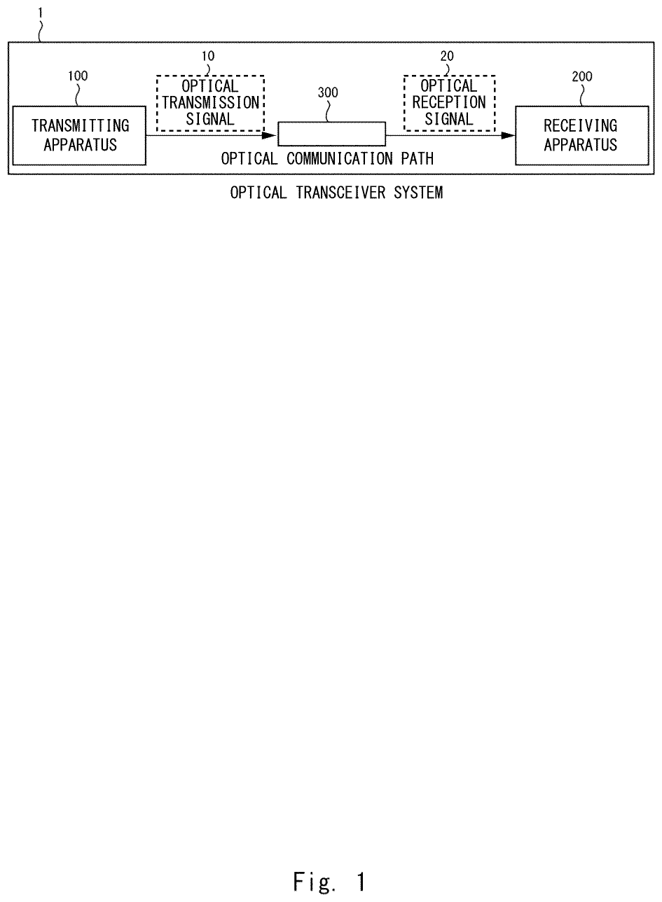

FIG. 1 shows an example of an optical transceiver system to which a state-of-polarization monitoring apparatus according to an aspect of the present disclosure is applied. The optical transceiver system 1 includes a transmitting apparatus 100, a receiving apparatus 200, and an optical communication path 300. The receiving apparatus 200 receives an optical signal transmitted from the transmitting apparatus 100 through the optical communication path 300. The optical communication path 300 is a communication path through which an optical signal can be transmitted, and is formed, for example, by using an optical fiber. Note that an optical signal transmitted from the transmitting apparatus 100 and an optical signal received by the receiving apparatus 200 are referred to as an optical transmission signal 10 and an optical reception signal 20, respectively.

Communication between the transmitting apparatus 100 and the receiving apparatus 200 is performed, for example, as follows. The transmitting apparatus 100 generates an optical transmission signal 10 from data (hereinafter also referred to as a message) to be transmitted to the receiving apparatus 200. Specifically, the transmitting apparatus 100 divides the message into a plurality of frames, and generates a symbol sequence by encoding data of each frame into a symbol. Then, the transmitting apparatus 100 modulates each of an X-polarized wave and a Y-polarized wave of an optical carrier wave based on the symbol sequence, and thereby generates the optical transmission signal 10 that is dual-polarized.

The receiving apparatus 200 restores a message from an optical reception signal 20. To do so, the receiving apparatus 200 converts the optical reception signal 20 into a digital signal. Further, the receiving apparatus 200 obtains a symbol sequence by dividing the obtained digital signal into a plurality of frames and converting each of the frames into a symbol. Then, the receiving apparatus 200 obtains a message by decoding each of the symbols of the symbol sequence.

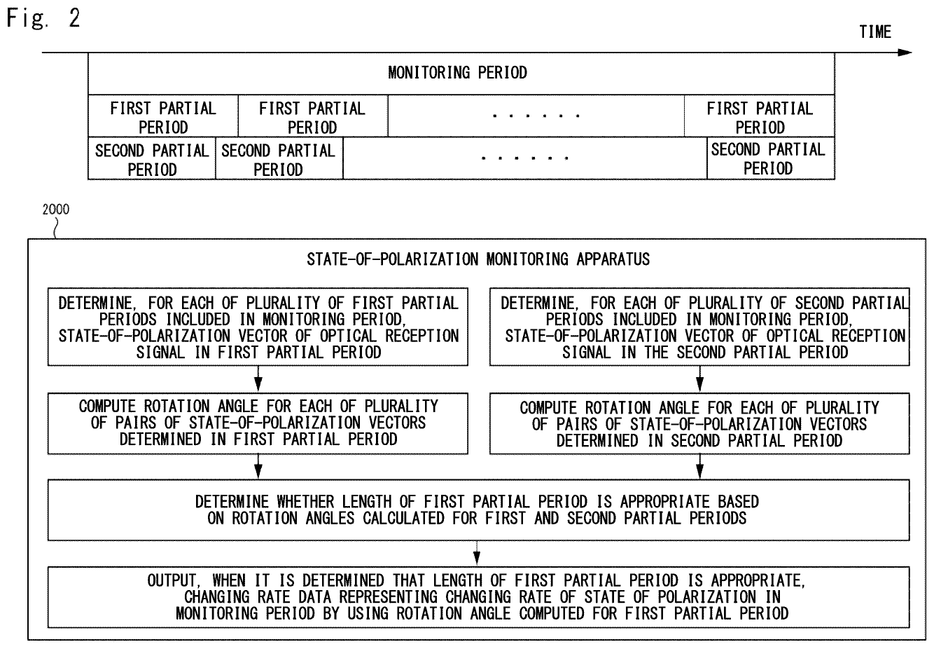

FIG. 2 shows an example of an overview of operations performed by a state-of-polarization monitoring apparatus 2000. Note that FIG. 2 is a diagram for facilitating the understanding of the overview of the state-of-polarization monitoring apparatus 2000, and the operations performed by the state-of-polarization monitoring apparatus 2000 are not limited to those shown in FIG. 2.

The state-of-polarization monitoring apparatus 2000 monitors the state of polarization of the optical reception signal 20. Specifically, the state-of-polarization monitoring apparatus 2000 handles changing rate data that represents the changing rate of the state of polarization of the optical reception signal 20 in the monitoring period as one of the indices for monitoring the change in the state of polarization of the optical reception signal 20.

The monitoring period can be arbitrarily determined. For example, a plurality of monitoring periods can be obtained by dividing a period during which the state-of-polarization monitoring apparatus 2000 is receiving an optical reception signal 20 into a plurality of periods each having a predetermined length.

Hereinafter, a monitoring period for which the state-of-polarization monitoring apparatus 2000 computes changing rate data is referred to as a target monitoring period. For example, when the state-of-polarization monitoring apparatus 2000 computes changing rate data for an i-th monitoring period, the i-th monitoring period is referred to as the target monitoring period, wherein i is an integer). The state-of-polarization monitoring apparatus 2000 successively handles each of a plurality of monitoring periods as the target monitoring period in a chronological order, and by doing so, attempts to successively compute changing rate data for each of the plurality of monitoring periods.

The state of polarization of the optical reception signal 20 can be represented by a vector in a Stokes space. Hereinafter, a vector in the Stokes space representing the state of polarization of an optical reception signal 20 is referred to as a “state-of-polarization vector (SOP vector)”. The SOP vector is a vector whose initial point is the origin of the Stokes space and the ending point is a point in the Stokes space representing the state of polarization of the optical reception signal 20. Hereinafter, a point in the Stokes space representing the state of polarization of an optical reception signal 20 is referred to as a “SOP point”.

The magnitude of a change in a state of polarization can be expressed by a rotation angle of the SOP vector. The rotation angle of an SOP vector is referred to as a state-of-polarization rotation angle (SOP rotation angle). For example, assume that the state of polarization of the optical reception signal 20 changes from a state represented by an SOP vector v1 to a state represented by an SOP vector v2. In this case, the magnitude of the change in the state of polarization of the optical reception signal 20 is represented by the SOP rotation angle from the vector v1 to the vector v2 (i.e., by the angle formed by the vectors v1 and v2).

The state-of-polarization monitoring apparatus 2000 performs the following processes for the optical reception signal 20 in the target monitoring period. The state-of-polarization monitoring apparatus 2000 determines, for each of a plurality of first partial periods obtained from the target monitoring period, an SOP vector representing the state of polarization of the optical reception signal 20 in the first partial period. Similarly, the state-of-polarization monitoring apparatus 2000 determines, for each of a plurality of second partial periods obtained from the target monitoring period, an SOP vector representing the state of polarization of the optical reception signal 20 in the second partial period. Hereinafter, an SOP vector computed for the first partial period and an SOP vector computed for the second partial period are referred to as a first SOP vector and a second SOP vector, respectively.

The length of the target monitoring period and the length of the first partial period are represented by P0 and P1, respectively. In this case, when no interval is provided between first partial periods, the number of first partial periods obtained from the target monitoring period is [P0/P1]. Note that [x] represents a largest integer equal to or smaller than x. Hereinafter, the number of first partial periods included in the target monitoring period is represented by N.

The length of the second partial period is shorter than the length of the first partial period. The length of the second partial period is represented by P2. Further, the number of the second partial periods included in the target monitoring period is represented by M. When no interval is provided between second partial periods, M can be expressed as M=[P0/P2].

The length of the second partial period may be determined in advance or computed based on the length of the first partial period. In the latter case, for example, the state-of-polarization monitoring apparatus 2000 computes the length P2 of the second partial period by multiplying the length of the first partial period by a predetermined constant k1. That is, P2 can be expressed as P2=k1*P1. k1 is a real number satisfying the condition 0<k1<1. Alternatively, for example, the length P2 of the second partial period may be computed by subtracting a predetermined constant k2 from the length P1 of the first partial period. k2 is a real number satisfying the condition 0<k2<P1.

The state-of-polarization monitoring apparatus 2000 computes an SOP rotation angle for each of a plurality of pairs of the first SOP vectors. For example, assume that a first SOP vector in a certain first partial period is represented by v1 and a first SOP vector in the next first partial period is represented by v2. In this case, the state-of-polarization monitoring apparatus 2000 computes an SOP rotation angle for a pair of these two first partial periods by computing the angle formed by the vectors v1 and v2. Similarly, the state-of-polarization monitoring apparatus 2000 computes an SOP rotation angle for each of a plurality of pairs of second SOP vectors. Hereinafter, an SOP rotation angle computed for a pair of first partial periods is referred to as a first SOP rotation angle. Further, an SOP rotation angle computed for a pair of second partial periods is referred to as a second SOP rotation angle.

The state-of-polarization monitoring apparatus 2000 determines whether the length of the first partial period is appropriate or not based on the computed first and second SOP rotation angles. When it is determined that the length of the first partial period is appropriate, the state-of-polarization monitoring apparatus 2000 outputs changing rate data for the target monitoring period by using the first SOP rotation angle.

When it is determined that the length of the first partial period is not appropriate, the state-of-polarization monitoring apparatus 2000 does not output changing rate data. In this case, the state-of-polarization monitoring apparatus 2000 may output information indicating that the length of the first partial period is not appropriate (hereinafter also referred to as alert information).

### Example of Advantageous Effect

The state-of-polarization monitoring apparatus 2000 computes changing rate data representing the changing rate of the state of polarization as one of indicators for monitoring the state of polarization of the optical reception signal 20 received by the receiving apparatus 200. As the changing rate data, the speed of the rotation of the SOP vector, i.e., the rotation speed of the SOP vector, is used.

The rotation speed of the SOP vector can be computed by dividing the rotation angle of the state of polarization by the observation time. Note that when the observation period is too long, the rotation speed of the SOP vector cannot be correctly computed because the SOP vector rotates 360° or larger (i.e., because of the occurrence of the so-called aliasing).

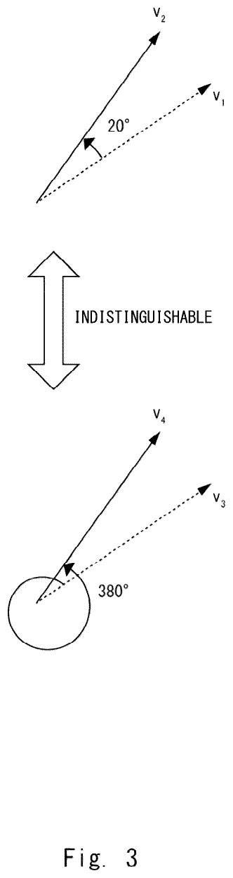

FIG. 3 shows an example of aliasing related to the rotation angle of a state of polarization. In an example shown on the upper side, the SOP vector at the start point of the observation period is shown as a vector v1, and the SOP vector at the end point of the observation period is shown as a vector v2. The SOP vector has rotated 20° from the vector v1 to the vector v2.

Meanwhile, in an example shown on the lower side, an SOP vector at the start point of the observation period is shown as a vector v3, and an SOP vector at the end point of the observation period is shown as a vector v4. The SOP vector has rotated 380° from the vector v3 to the vector v4.

Note that in the method in which a rotation angle is computed by using the SOP vectors at the start point and end point of the observation period, it is impossible to distinguish between the case shown on the upper side and the case shown on the lower side. Therefore, when the observation period is too long, the SOP vector rotates 360° or larger in the observation period as shown in the example on the lower side in FIG. 3, thus making it impossible to correctly compute the rotation angle of the SOP vector. As a result, the changing rate data also cannot be correctly computed.

In this regard, according to the state-of-polarization monitoring apparatus 2000, it is determined whether the length of the first partial period is appropriate or not by the above-described method. Then, when the length of the first partial period is appropriate, changing rate data is computed by using the SOP rotation angle computed for the first partial period. Therefore, according to the state-of-polarization monitoring apparatus 2000, changing rate data is computed only when the changing rate data can be correctly computed. Therefore, according to the state-of-polarization monitoring apparatus 2000, correct changing rate data can be obtained.

The state-of-polarization monitoring apparatus 2000 according to this example embodiment will be described hereinafter in a more detailed manner.

### Example of Functional Configuration

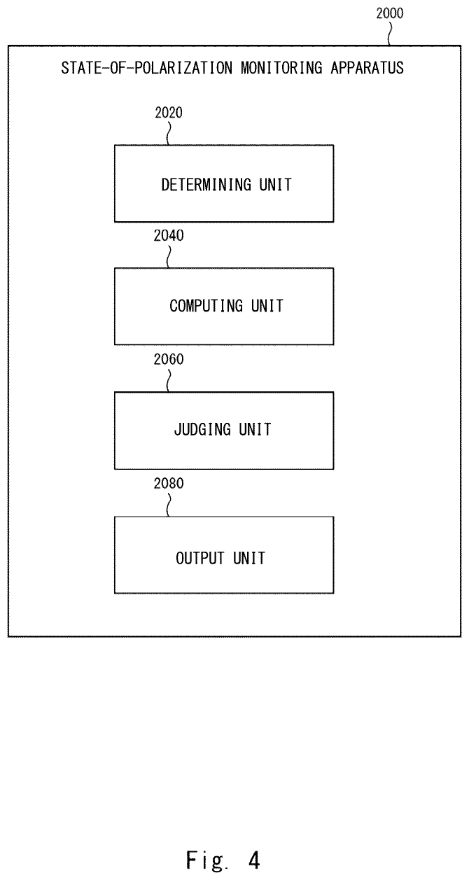

FIG. 4 is a first block diagram showing an example of a functional configuration of the state-of-polarization monitoring apparatus 2000. The state-of-polarization monitoring apparatus 2000 includes a determining unit 2020, a computing unit 2040, a judging unit 2060, and an output unit 2080. The determining unit 2020 determines a first SOP vector for each of a plurality of first partial periods obtained from the target monitoring period. Further, the determining unit 2020 determines a second SOP vector for each of a plurality of second partial periods obtained from the target monitoring period.

The computing unit 2040 computes a first SOP rotation angle for each of a plurality of pairs of first SOP vectors. Further, the computing unit 2040 computes a second SOP rotation angle for each of a plurality of pairs of second SOP vectors.

The judging unit 2060 determines whether the length of the first partial period is appropriate or not based on the computed first and second SOP rotation angles. When it is determined that the length of the first partial period is appropriate, the output unit 2080 outputs changing rate data.

### Example of Hardware Configuration

Each of functional components of the state-of-polarization monitoring apparatus 2000 can be implemented by hardware that implements the functional component (e.g., a hardwired electronic circuit or the like) or by a combination of hardware and software (e.g., a combination of an electronic circuit and a program for controlling it or the like). A case where each of the functional components of the state-of-polarization monitoring apparatus 2000 is implemented by a combination of hardware and software will be further described hereinafter.

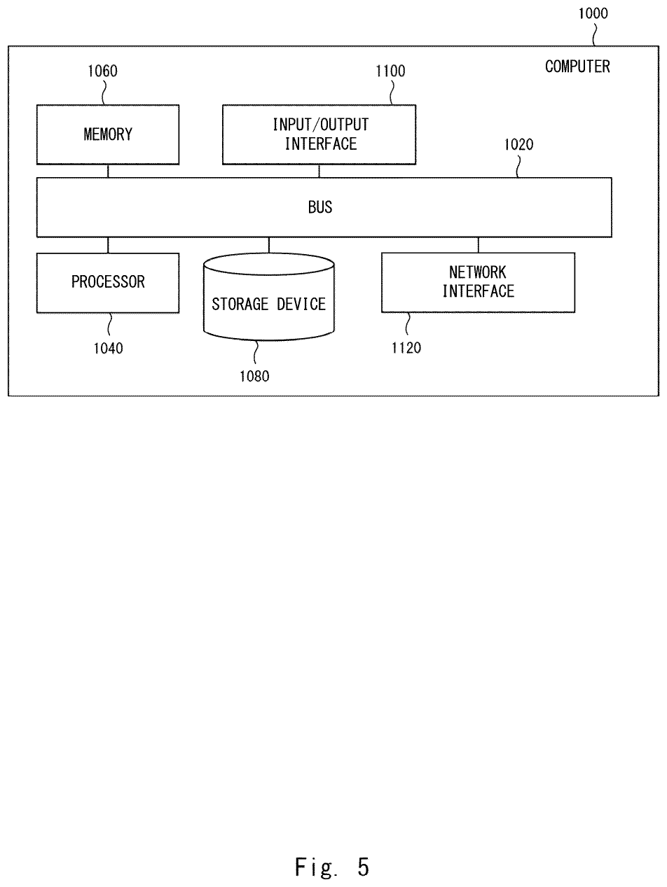

FIG. 5 is a block diagram showing an example of a hardware configuration of a computer 1000 that implements the state-of-polarization monitoring apparatus 2000. The computer 1000 is an arbitrary computer. For example, the computer 1000 is a stationary computer such as a server machine or a PC (Personal Computer). Alternatively, for example, the computer 1000 is a portable computer such as a smartphone or a tablet-type terminal. Alternatively, for example, the computer 1000 is a semiconductor chip such as an SoC (System on Chip). The computer 1000 may be a special-purpose computer designed to implement the state-of-polarization monitoring apparatus 2000, or may be a general-purpose computer.

For example, each of functions of the state-of-polarization monitoring apparatus 2000 is implemented by the computer 1000 by installing a predetermined application in the computer 1000. The aforementioned application is implemented by a program for implementing each of the function components of the state-of-polarization monitoring apparatus 2000. Note that how to acquire the aforementioned program is arbitrarily determined. For example, the program can be acquired from a storage medium (such as a Digital Versatile Disk (DVD) or a Universal Serial Bus (USB) memory) in which the program is stored. Alternatively, the program can be acquired, for example, by downloading the program from a server apparatus that manages a storage device in which the program is stored.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 transmit and receive data to and from each other. However, the method for connecting the processor 1040 and the like to each other is not limited to connections through buses.

The processor 1040 is any of various types of processors such as a central processing unit (CPU), a graphics processing unit (GPU), digital signal processor (DSP), or a field-programmable gate array (FPGA). The memory 1060 is a primary storage device implemented by using a random access memory (RAM) or the like. The storage device 1080 is a secondary storage device implemented by using a hard disk drive, a solid state drive (SSD), a memory card, or a read only memory (ROM).

The input/output interface 1100 is an interface for connecting the computer 1000 with an input/output device(s). For example, an input device such as a keyboard and an output device such as a display device are connected to the input/output interface 1100.

The network interface 1120 is an interface for connecting the computer 1000 to a network. The network may be a local area network (LAN) or a wide area network (WAN).

In the storage device 1080, programs for implementing respective functional components of the state-of-polarization monitoring apparatus 2000 (programs for implementing the above-described applications) are stored. The processor 1040 implements each of functional components of the state-of-polarization monitoring apparatus 2000 by loading the aforementioned program onto the memory 1060 and executing the loaded program.

The state-of-polarization monitoring apparatus 2000 may be implemented by one computer 1000 or by a plurality of computers 1000. In the latter case, the configurations of the computers 1000 do not need to be identical to each other, but can be different from each other.

The state-of-polarization monitoring apparatus 2000 may be integrally implemented with the receiving apparatus 200. In this case, the various functional components of the state-of-polarization monitoring apparatus 2000 are implemented inside the receiving apparatus 200. In this way, the receiving apparatus 200 also functions as the state-of-polarization monitoring apparatus 2000.

### <Flow of Processes>

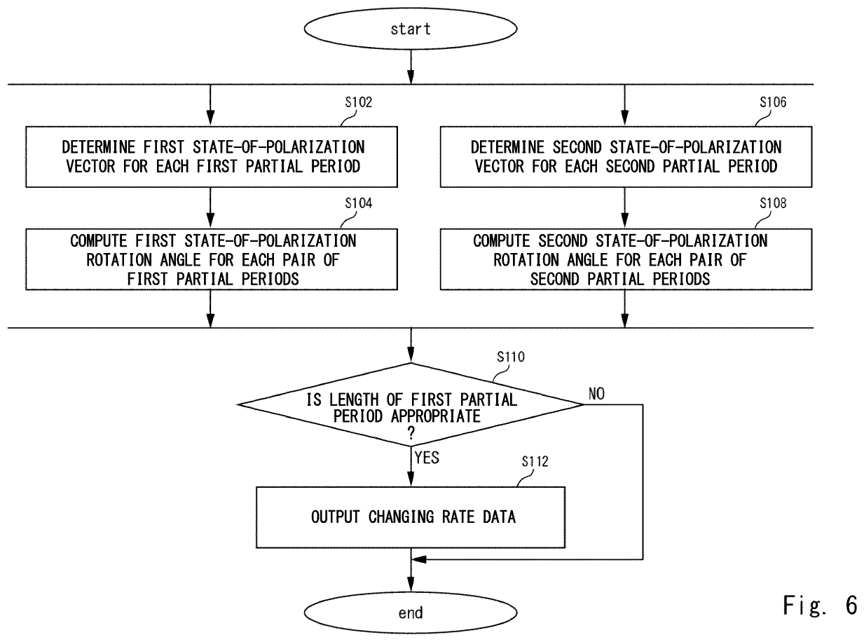

FIG. 6 shows a first flowchart showing an example of a flow of processes performed by the state-of-polarization monitoring apparatus 2000. The series of processes shown in FIG. 6 is successively (i.e., repeatedly) performed for a plurality of target monitoring periods.

The determining unit 2020 determines a first SOP vector for each of a plurality of first partial periods obtained from the target monitoring period (S102). The computing unit 2040 computes a first SOP rotation angle for each of a plurality of pairs of first SOP vectors (S104).

The determining unit 2020 determines a second SOP vector for each of a plurality of second partial periods obtained from the target monitoring period (S106). The computing unit 2040 computes a second SOP rotation angle for each of a plurality of pairs of second SOP vectors (S108).

The judging unit 2060 determines whether the length of the first partial period is appropriate or not based on the plurality of computed first and second SOP rotation angles (S110). When it is determined that the length of the first partial period is appropriate (S110: Yes), the output unit 2080 outputs changing rate data (S112).

When it is determined that the length of the first partial period is not appropriate (S110: No), various processes may be performed by the state-of-polarization monitoring apparatus 2000. For example, the state-of-polarization monitoring apparatus 2000 outputs an alert message indicating that the length of the first partial period is not appropriate. Alternatively, for example, as will be described later in a second example embodiment, the state-of-polarization monitoring apparatus 2000 may change the length of the first partial period.

The flow of processes performed by the state-of-polarization monitoring apparatus 2000 is not limited to the flow shown in FIG. 6. For example, in FIG. 6, the processes for the first partial period (S102 and S104) and those for the second partial period (S106 and S108) may be performed in parallel with each other. However, these processes may be performed one after another instead of being performed in parallel. For example, the steps S106 and S108 may be performed after the steps S102 and S104 are performed.

### <Determination of SOP Vector: S102, S106>

The determining unit 2020 determines a first SOP vector for each of a plurality of first partial periods (S102). Further, the determining unit 2020 determines a second SOP vector for each of a plurality of second partial periods (S106). Some examples of a method for determining an SOP vector will be shown hereinafter, in which first and second partial periods are collectively referred to as “partial periods”. In the following description, when the partial period represents a first partial period, the SOP vector represents a first SOP vector. On the other hand, when the partial period represents a second partial period, the SOP vector represents a second SOP vector.

### Example 1 of Method for Determining SOP Vector

For example, the determining unit 2020 determines an SOP vector for each partial period by using a polarimeter. When a polarimeter is used to determine an SOP vector, this polarimeter is provided in the receiving apparatus 200 in advance. An optical reception signal 20 is input to the polarimeter.

The polarimeter is an apparatus that measures the state of polarization of the input light. For example, the polarimeter outputs, upon receiving an optical reception signal 20, time-series data {S[t]} of Stokes vectors S each of which represents a state of polarization of the optical reception signal 20 (i.e., time-series data {S[t]} including a plurality of Stokes vectors S arranged in a chronological order). Note that t represents time. The Stokes vector S is a vector in which four types of Stokes parameters s0, s1, s2, and s3 are enumerated.

The Stokes space is a three-dimensional (3D) space defined by three axes, i.e., an s1-axis, an s2-axis, and an s3-axis. Therefore, the SOP vector v[t] of an optical reception signal 20 at a time point t can be expressed as v[t]=(s1[t], s2[t], s3[t]) by using three Stokes parameters s1[t], s2[t], and s3[t] output from the polarimeter to which the optical reception signal 20 is input at the time point t.

Therefore, the determining unit 2020 acquires time-series data of Stokes vectors output from the polarimeter provided in the receiving apparatus 200. Then, the determining unit 2020 determines, for each partial period, the SOP vector for the partial period by using at least one Stokes vector for the partial period.

For example, the determining unit 2020 acquires a representative Stokes vector S[rj] for each partial period j. The time point rj is, for example, a specific time point in the partial period j (e.g., the start point or the end point of the partial period j). Further, the determining unit 2020 extracts Stokes parameters s1[rj], s2[rj], and s3[rj] from the representative Stokes vector S[rj]. Then, the determining unit 2020 determines a vector (s1[rj], s2[rj], s3[rj]) determined by these parameters as the SOP vector for the partial period j.

Alternatively, for example, the determining unit 2020 computes statistical values ss1[j], ss2[j], and ss3[j] of the Stokes parameters s1, s2, and s3, respectively, by using a plurality of Stokes vectors for the partial period j. Then, the determining unit 2020 determines a vector (ss1[j], ss2[j], ss3[j]) determined by the computed statistical values as the SOP vector for the partial period j.

There are various methods by which the determining unit 2020 acquires Stokes vectors output from the polarimeter. For example, the receiving apparatus 200 transmits Stokes vectors output from the polarimeter to the state-of-polarization monitoring apparatus 2000. In this case, the determining unit 2020 receives Stokes vectors transmitted from the state-of-polarization monitoring apparatus 2000, and thereby acquires the Stokes vectors. Alternatively, for example, the receiving apparatus 200 stores Stokes vectors output from the polarimeter into a storage unit accessible from the state-of-polarization monitoring apparatus 2000. In this case, the determining unit 2020 acquires Stokes vectors from this storage unit.

Note that when only the representative Stokes vector is used to determine the SOP vector, the receiving apparatus 200 may be configured to transmit only the representative Stokes vector or to store only the representative Stokes vector into the storage unit.

### Example 2 of Method for Determining SOP Vector

The determining unit 2020 acquires, each frame of an optical reception signal 20, sample data representing the state of polarization of the optical reception signal 20 in that frame. For example, the sample data is a Jones vector. Further, the determining unit 2020 maps sample data of each frame to a point in a Stokes space, and by doing so, obtains a corresponding point for each sample data.

A Stokes vector S[t]=(s0[t], s1[t], s2[t], s3[t]) can be obtained from sample data at a time point t. Therefore, the determining unit 2020 obtains a point (s1[t], s2[t], s3[t]) as a corresponding point corresponding to the sample data at the time point t.

A Stokes vector S[t] at a time point t can be computed as shown below by using sample data at the time point t.

$$\begin{matrix}[ Equation 1 ] & \\ S [ i ] = ( \begin{matrix}{s}_{0} [ i ] \\ {s}_{1} [ i ] \\ {s}_{2} [ i ] \\ {s}_{3} [ i ]\end{matrix} ) = ( \begin{matrix}{z}_{x} [ i ] {z}_{x} [ i \text{?} + {z}_{y} [ i ] {z}_{y} [ i \text{?} \\ {z}_{x} [ i ] {z}_{x} [ i \text{?} - {z}_{y} [ i ] {z}_{y} [ i \text{?} \\ {z}_{x} [ i \text{?} {z}_{y} [ i ] + {z}_{x} [ i ] {z}_{y} [ i \text{?} \\ - {jz}_{x} [ i \text{?} {z}_{y} [ i ] + {jz}_{x} [ i ] {z}_{y} [ i \text{?}\end{matrix} ) & ( 1 )\end{matrix}$$

$$\text{?} \text{indicates text missing or illegible when filed}$$

z_x[t] represents an x-polarized wave component of the optical reception signal 20 at the time point t, indicated by the sample data at the time point t. z_y[t] represents a y-polarized wave component of the optical reception signal 20 at the time point t, indicated by the sample data at the time point t. * represents conjugate. j represents an imaginary unit. Note that z_x[t] and z_y[t] are both complex numbers.

Note that the number of frames included in the optical reception signal 20 in each partial period is represented by n. In this case, the determining unit 2020 computes one SOP vector for each partial period based on n corresponding points obtained for n frames included in the partial period. Hereinafter, a set of corresponding points obtained for a plurality of frames included in a partial period is referred to as a corresponding point group corresponding to these frames. The corresponding point group of the respective frames includes n corresponding points.

For example, the determining unit 2020 performs the following processes for each partial period. Firstly, the determining unit 2020 computes a plane in a Stokes space that fits to a corresponding point group obtained for the target partial period (i.e., fits to n corresponding points included in the corresponding point group). The determining unit 2020 determines, as the SOP vector, a vector whose ending point is at the intersection between the normal vector of the plane and the Poincaré sphere and whose initial point is at the origin of the Stokes space.

Note that the normal vector is determined so as to pass through the origin of the Stokes space. Further, there may be two normal vectors that pass through a specific point on a certain plane. Therefore, it is assumed that a rule for selecting the normal vector to be used to compute the SOP point from these two normal vectors has already been determined in advance.

Note that a plane in a Stokes space can be expressed as follows.

$$\begin{matrix}[ Equation 2 ] & \\ A * {s}_{1} + B * {s}_{2} + C * {s}_{3} + D = 0 & ( 2 )\end{matrix}$$

A, B, C, and D are real numbers.

Therefore, for example, the determining unit 2020 computes a plane fitting to the corresponding point group by computing A, B, C, and D that satisfy Equation (2) by using the corresponding point group. For example, the determining unit 2020 substitutes each of the corresponding points included in the corresponding point group into Equation (2) and performs singular value decomposition (SVD). In this way, since A, B, C, and D in Equation (2) are computed, a plane fitting to the corresponding point group is computed.

Note that in the case where quadrature amplitude modulation (QAM) is used, the corresponding point group is located inside a lens-shaped area that is obtained by combining an area defined by the following Equation (3) and an area defined by the following Equation (4).

$$\begin{matrix}[ Equation 3 ] & \\ S = \frac{1}{2} ( \begin{matrix}1 + {r}^{2} \\ 1 - {r}^{2} \\ 2 r cos φ \\ 2 r sin φ\end{matrix} ) & ( 3 )\end{matrix}$$

$$\begin{matrix}[ Equation 4 ] & \\ S = \frac{1}{2} ( \begin{matrix}{r}^{2} + 1 \\ {r}^{2} - 1 \\ 2 r cos φ \\ - 2 r sin φ\end{matrix} ) & ( 4 )\end{matrix}$$

In Equation (4), φ and r represent the phase angle of the optical signal and the normalized amplitude thereof, respectively. Further, φ and r satisfy conditions 0<=φ<2π and 0<=r<=1, respectively.

A method for deriving Equation (3) is disclosed in NPL2. In the derivation of Equation (3), a point having the maximum amplitude is selected for the H-polarization state. Further, all the points in the unit circle on the imaginary plane are taken into consideration for the V-polarization state. These facts are expressed by the following Jones vector.

$$\begin{matrix}[ Equation 5 ] & \\ J = \frac{1}{\sqrt{2}} ( \begin{matrix}1 \\ {re}^{j φ}\end{matrix} ) & ( 5 )\end{matrix}$$

Equation (3) is obtained by transforming the Jones vector expressed by Equation (5) into a Stokes vector.

Meanwhile, in the derivation of Equation (4), a point having the maximum amplitude is selected for the V-polarization state, and an arbitrary point(s) in the unit circle on the imaginary plane is taken into consideration for the H-polarization state. These facts are expressed by the below-shown Jones vector.

$$\begin{matrix}[ Equation 6 ] & \\ J = \frac{1}{\sqrt{2}} ( \begin{matrix}{re}^{j φ} \\ 1\end{matrix} ) & ( 6 )\end{matrix}$$

Equation (4) is obtained by transforming the Jones vector expressed by Equation (6) into a Stokes vector.

Based on Equations (3) and (4), the aforementioned lens-shaped area is an area that is point-symmetrical with respect to the origin. Therefore, a plane that fits to the corresponding point group distributed inside this lens-shaped area passes through the origin. Therefore, it can be presumed that D is equal to zero (D=0) in Equation (2).

Therefore, the determining unit 2020 may compute a plane that fits to the corresponding point group by computing A, B, and C that satisfy the following equation by using the corresponding point group.

$$\begin{matrix}[ Equation 7 ] & \\ A * {s}_{1} + B * {s}_{2} + C * {s}_{3} = 0 & ( 7 )\end{matrix}$$

A, B, and C are real numbers.

Note that similarly to the case where Equation (2) is used, when Equation (7) is used, a plane that fits to the corresponding point group can also be computed by a method such as singular value decomposition.

The method for computing one SOP vector based on a plurality of corresponding points is not limited to the above-described method using a plane that fits to a plurality of corresponding points. For example, the determining unit 2020 may compute one corresponding point based on a plurality of corresponding points by using a method disclosed in NPL1, and compute an SOP vector whose ending point is the computed corresponding point.

There are various methods by which the determining unit 2020 acquires sample data. For example, the receiving apparatus 200 is configured to generate sample data for each frame of an optical reception signal 20 and transmit the generated sample data to the state-of-polarization monitoring apparatus 2000. In this case, the determining unit 2020 receives sample data transmitted from the state-of-polarization monitoring apparatus 2000, and thereby acquires the sample data. Alternatively, for example, the receiving apparatus 200 is configured to store sample data generated for each frame of an optical reception signal 20 into a storage unit accessible from the state-of-polarization monitoring apparatus 2000. In this case, the determining unit 2020 acquires sample data from this storage unit.

Note that in the case where the determining unit 2020 acquires sample data only for the representative frame, the receiving apparatus 200 may be configured to generate sample data only for the representative frame.

### <Computation of SOP Rotation Angle: S104, S108>

The computing unit 2040 computes a first SOP rotation angle for each of a plurality of pairs of first SOP vectors (S104). Further, the computing unit 2040 computes a second SOP rotation angle for each of a plurality of pairs of second SOP vectors (S108). A method for computing an SOP rotation angle will be described hereinafter, in which the first and second SOP rotation angles are collectively referred to as “SOP rotation angles”. Note that in the following description, the first and second SOP vectors are collectively referred to as SOP vectors. When the SOP vector means a first SOP vector, the SOP rotation angle means a first SOP rotation angle. On the other hand, when the SOP vector means a second SOP vector, the SOP rotation angle means a second SOP rotation angle.

A pair of the SOP vectors includes, for example, SOP vectors adjacent to each other in time-series data of the SOP vectors (i.e., a plurality of SOP vectors arranged in a chronological order). For example, a set of pairs of the SOP vectors {(v[1], v[2]), (v[2], v[3]), . . . , (v[m−1], v[m])} is obtained from the time-series data of the SOP vectors (v[1], v[2], v[3], . . . , v[m]).

The state-of-polarization monitoring apparatus 2000 computes an SOP rotation angle for each of pairs included in the aforementioned set. Specifically, the state-of-polarization monitoring apparatus 2000 computes an SOP rotation angle a[1] for a pair of SOP vectors (v[1], v[2]), an SOP rotation angle a[2] for a pair of SOP vectors (v[2], v[3]), . . . , and an SOP rotation angle a[m−1] for a pair of SOP rotation vectors (v[m−1], v[m]). In this way, time-series data (a[1], a[2], . . . , a[m−1]) of SOP rotation angles is obtained for the set of pairs of SOP vectors {(v[1], v[2]), (v[2], v[3]), . . . , (v[m−1], v[m])}. Note that an i-th SOP rotation angle a[i] is computed by computing an angle formed by SOP vectors v[i] and v[i+1].

### <Determination of Appropriateness of Length of First Partial Period: S110>

The judging unit 2060 determines whether the length of the first partial period is appropriate or not by using the first and second SOP rotation angles (S110). Note that, in general, the magnitude of a first SOP rotation angle with respect to a second SOP rotation angle increases in proportion to the length of the first partial period with respect to the length of the second partial period. However, when the first partial period is too long, the proportional relationship no longer holds due to the occurrence of aliasing.

Therefore, for example, the judging unit 2060 determines whether the length of the first partial period is appropriate or not by using a condition that is valid only when the aforementioned proportional relationship holds. For example, the judging unit 2060 computes an index value I1 defined by the following Equation (8).

$$\begin{matrix}[ Equation 8 ] & \\ {I}_{1} = \vert \frac{{P}_{2} * \frac{1}{N - 1} {\sum }_{i} {a}_{1} [ i ]}{{P}_{1} * \frac{1}{M - 1} {\sum }_{i} {a}_{2} [ i ]} - 1 \vert & ( 8 )\end{matrix}$$

P1 represents the length of the first partial period. P2 represents the length of the second partial period. N represents the number of first partial periods. M represents the number of second partial periods. a1[i] represents an i-th first SOP rotation angle. a2[i] represents an i-th second SOP rotation angle.

Note that, in theory, the index value I1 becomes zero when the above-described proportional relationship holds, and the index value I1 becomes larger than zero when the above-described proportional relationship does not hold. However, in practice, even in a situation where the above-described proportional relationship holds, the index value I1 may become larger than zero due to an error or the like.

Therefore, for example, the judging unit 2060 determines whether or not the index value I1 is equal to or larger than a predetermined threshold α. The threshold α satisfies a condition 0<α<1. When the index value I1 is equal to or greater than the threshold α, the judging unit 2060 determines that the length of the first partial period is not appropriate (S110: No). On the other hand, when the index value I1 is smaller than the threshold α, the judging unit 2060 determines that the length of the first partial period is appropriate (S110: Yes).

Note that it is assumed that the value of the threshold α is determined in advance. The value of the threshold α can be arbitrarily determined. For example, α is set to a value closer to zero as the accuracy of computation by the state-of-polarization monitoring apparatus 2000 is higher (i.e., the error of computation is smaller). Further, the value a may be determined based on the length of the partial period.

### <Output of Changing Rate Data: S112>

When it is determined that the length of the first partial period is appropriate, the output unit 2080 outputs changing rate data (S112). Therefore, the output unit 2080 computes changing rate data.

As will be described hereinafter, there are various methods for computing changing rate data. For example, the output unit 2080 is configured in advance to compute changing rate data according to a specific method. Alternatively, for example, the output unit 2080 may dynamically select a computation method to be used from among a plurality of computation methods, and compute the changing rate data using the selected method.

Some specific examples of a method for computing the changing rate data will be described hereinafter.

### Example 1 of Method for Computing Changing Rate Data

For example, the output unit 2080 computes a rotation angle per unit time (i.e., a rotational speed per unit time) for each of a plurality of first SOP rotation angles computed by the computing unit 2040. Then, the output unit 2080 computes a statistical value (e.g., an average value) of a plurality of computed rotation speeds as the changing rate data in the target monitoring period. Hereinafter, this computation method is referred to as an “adjacent method”.

As a premise, it is assumed that time-series data (v1[1], v1[2], . . . , v1[N]) of first SOP vectors has already been obtained by the determining unit 2020. Further, time-series data (a1[1], a1[2], . . . , a1[N−1]) of first SOP rotation angles has already been obtained by the computing unit 2040.

The output unit 2080 computes a rotational speed w[i] for each first SOP rotation angle a1[i]. As a result, time-series data (w[1], w[2], . . . , w[N−1]) of rotational speeds is obtained. Then, the output unit 2080 computes an average value wo of the rotational speeds w[1], w[2], . . . , w[N−1] as the changing rate data in the target monitoring period.

The rotation speed w[i] can be computed by dividing the first SOP rotation angle a1[i] by the observation time. Specifically, it can be computed by using the following Equation (9).

$$\begin{matrix}[ Equation 9 ] & \\ w [ i ] = \frac{a 1 [ i ]}{t [ i + 1 ] - t [ i ]} & ( 9 )\end{matrix}$$

t[i] represents a time point corresponding to an i-th first partial period. The time point corresponding to a certain first partial period is a specific time point related to that first partial period, such as the start point or the end point of the first partial period.

When there is no interval between first partial periods, the observation time is equal to the length P1 of the first partial period. On the other hand, when there is an interval between first partial periods, the observation time is equal to the sum of the length P1 of the first partial period and the length of the interval between first partial periods.

### Example 2 of Method for Computing Changing Rate Data

The output unit 2080 computes changing rate data of the target monitoring period using, among the first SOP vectors computed for the target monitoring period, the SOP vectors at the head and tail in the time series (i.e., the first and last SOP vectors in the time-series data). That is, the output unit 2080 computes an angle formed by the SOP vector at the head and the SOP vector at the tail, and computes the changing rate data of the target monitoring period by dividing the computed angle by the observation time. Hereinafter, this computation method is referred to as a “head-to-tail method”.

As a premise, it is assumed that time-series data (v1[1], v1[2], . . . , v1[N]) of first SOP vectors has already been obtained. The output unit 2080 computes an angle formed by the SOP vector v1[1] at the head and the SOP vector v1[N] at the tail. Then, the output unit 2080 computes changing rate data wo by dividing the computed angle by the observation time. When the symbol t used in Equation (9) is used, the observation time can be expressed as t[N]−t[1].

### Example of Selecting Method

For example, the computing unit 2040 selects either the adjacent method or the head-to-tail method based on the sum of first SOP rotation angles, i.e., a1[1]+a1[2]+ . . . +a1[N−1]. More specifically, the computing unit 2040 selects the adjacent method when the sum of first SOP rotation angles is equal to or larger than a threshold. On the other hand, the computing unit 2040 selects the head-to-tail method when the sum of first SOP rotation angles is smaller than the threshold. This threshold is, for example, π/2.

<Case where Length of First Partial Period is not Appropriate>

When it is determined that the length of the first partial period is not appropriate, various processes may be performed by the state-of-polarization monitoring apparatus 2000. For example, the state-of-polarization monitoring apparatus 2000 starts a process for the next monitoring period in response to the determination that the length of the first partial period is not appropriate. In this case, the state-of-polarization monitoring apparatus 2000 may generate and output alert information indicating that “the length of the first partial period is not appropriate”.

### <Method for Using Changing Rate Data>

The state-of-polarization monitoring apparatus 2000 computes changing rate data for each monitoring period. As a result, time-series data of changing rate data (i.e., time-series data including a plurality of pieces of changing rate data arranged in a chronological order) is obtained. The time-series data of changing rate data can be used for a process for detecting an abnormality in the state of polarization of an optical reception signal 20.

For example, the state-of-polarization monitoring apparatus 2000 detects an abnormality in the state of polarization of the optical reception signal 20 by detecting an abnormal value from time-series data of changing rate data. For example, it is assumed that the state-of-polarization monitoring apparatus 2000 has detected that pieces of the changing rate data between a p-th monitoring period and a q-th monitoring period has an abnormal value. In this case, the state-of-polarization monitoring apparatus 2000 determines that an abnormality has occurred in the state of polarization of the optical reception signal 20 in the period from the p-th monitoring period to the q-th monitoring period. Note that any of various existing techniques for detecting an abnormal value from time-series data can be used.

### <Method for Using Result of Detection of Abnormality in State of Polarization>

The detection of an abnormality of the state of polarization of the optical reception signal 20 can be used in various ways. For example, when it is found that the receiving apparatus 200 is malfunctioning, a history of analyses of the state of polarization of optical reception signals 20 in the receiving apparatus 200 (e.g., a history of time-series data of angular velocities or time-series data of statistical values of angular velocities described above) can be used to investigate the cause of the malfunction of the receiving apparatus 200. For example, it is assumed that an abnormality of the state of polarization of the optical reception signal 20 is detected at a certain time point earlier than the malfunction of the receiving apparatus 200. In this case, it is considered that an event that could cause an abnormality in the state of polarization of the optical reception signal 20, such as lightning, is related to the malfunction of the receiving apparatus 200.

Alternatively, for example, an abnormality of the receiving apparatus 200 may be predicted by monitoring the state of polarization of the optical reception signal 20. For example, when an abnormality occurs in the state of polarization of the optical reception signal 20, there is a possibility that an abnormality will occur in the receiving apparatus 200 thereafter. Therefore, for example, the system may be configured to receive messages from the transmitting apparatus 100 by using a receiving apparatus other than the receiving apparatus 200 when an abnormality of the state of polarization of the optical reception signal 20 that is received by the receiving apparatus 200 is detected.

### Modified Example

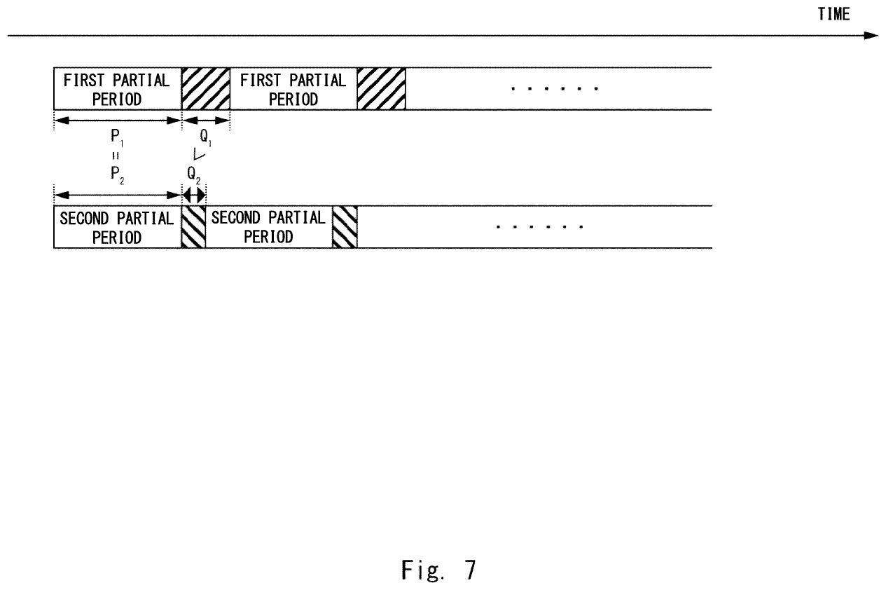

Instead of making the length of the first partial period longer than the length of the second partial period, the length of the interval between first partial periods may be made longer than the length of the interval between second partial periods. FIG. 7 shows a situation where the length of the interval between first partial periods and the length of the interval between second partial periods differs from each other. In FIG. 7, right-slanting diagonal lines represent the interval between first partial periods. Left-slanting diagonal lines represent the interval between second partial periods.

The length P1 of the first partial period and the length P2 of the second partial period are equal to each other (i.e., P1=P2). Meanwhile, the length Q1 of the interval between first partial periods is longer than the length Q2 of the interval between second partial periods (i.e., Q1>Q2).

The judging unit 2060 determines “whether the length of the interval between first partial periods is appropriate or not” instead of determining “whether the length of the first partial period is appropriate or not”. The specific method for this determination is the same as the method for determining “whether the length of the first partial period is appropriate or not” described above.

For example, the judging unit 2060 determines whether or not an index value I1 is equal to or larger than a threshold α. When the index value I1 is equal to or larger than the threshold α (i.e., I1≥α), the judging unit 2060 determines that the length of the interval between first partial periods is appropriate. On the other hand, when the index value I1 is smaller than the threshold α (i.e., I1≥α), the judging unit 2060 determines that the length of the interval between first partial periods is not appropriate.

### Second Example Embodiment

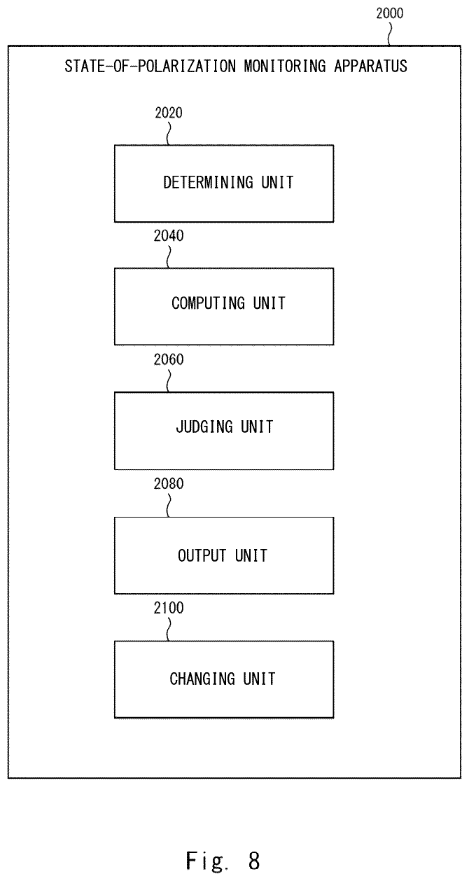

FIG. 8 is a second block diagram showing an example of a functional configuration of a state-of-polarization monitoring apparatus 2000. The state-of-polarization monitoring apparatus 2000 shown in FIG. 8 includes a changing unit 2100.

The state-of-polarization monitoring apparatus 2000 according to the second example embodiment changes the length of the first partial period in response to the determination that the length of the first partial period is not appropriate. The change of the length of the first partial period is performed by the changing unit 2100.

As described above, the state-of-polarization monitoring apparatus 2000 attempts to successively compute changing rate data for each of a plurality of monitoring periods. Therefore, when the length of the first partial period is changed in the processing for a certain monitoring period, the length changed by the changing unit 2100 is used as the length of the first partial period in the process for the next monitoring period and thereafter.

Therefore, according to the state-of-polarization monitoring apparatus 2000, in the case where states of polarization in a plurality of monitoring periods are successively monitored, it is possible, when the length of the first partial period is determined not to be appropriate in a certain monitoring period, to increase the probability that the length of the first partial period is determined to be appropriate in the subsequent monitoring periods. Therefore, according to the state-of-polarization monitoring apparatus 2000, it is possible to compute correct changing rate data for a larger number of monitoring periods than in the case where the length of the first partial period is not changed.

Further, for each monitoring period, the state-of-polarization monitoring apparatus 2000 may repeat the process for that monitoring period until the length of the first partial period becomes appropriate. In this way, it is possible to compute correct changing rate data for all the monitoring periods.

Note that when it is determined that the length of the first partial period is not appropriate by the method described in the first example embodiment, the length of the first partial period is longer than the appropriate length. Therefore, the changing unit 2100 reduces the length of the first partial period.

There are various methods for reducing the length of the first partial period. For example, the changing unit 2100 uses a value obtained by multiplying the current length P1 of the first partial period by a predetermined number d1 (i.e., a value expressed as d1*P1) as a new length of the first partial period. d1 is a real number satisfying a condition 0<d1<1.

Alternatively, for example, the changing unit 2100 uses a value obtained by subtracting a predetermined number d2 from the current length P1 of the first partial period (i.e., a value expressed as P1-d2) as a new length of the first partial period. d2 is a real number satisfying a condition 0<d2<P1.

The changing unit 2100 may change the length of the second partial period according to the change in the length of the first partial period. For example, it is assumed that the length P2 of the second partial period is a value obtained by multiplying the length P1 of the first partial period by a constant k1 as described above. In this case, the changing unit 2100 uses a value obtained by multiplying the changed length of the first partial period by the constant k1 as a new length of the second partial period.

### Example of Hardware Configuration

The hardware configuration of the state-of-polarization monitoring apparatus 2000 according to the second example embodiment is, for example, shown in FIG. 5 as in the case of the hardware configuration of the state-of-polarization monitoring apparatus 2000 according to the first example embodiment. However, a program(s) for implementing various functional components of the state-of-polarization monitoring apparatus 2000 according to the second example embodiment is stored in a storage device 1080 in the second example embodiment.

### <Flow of Processes>

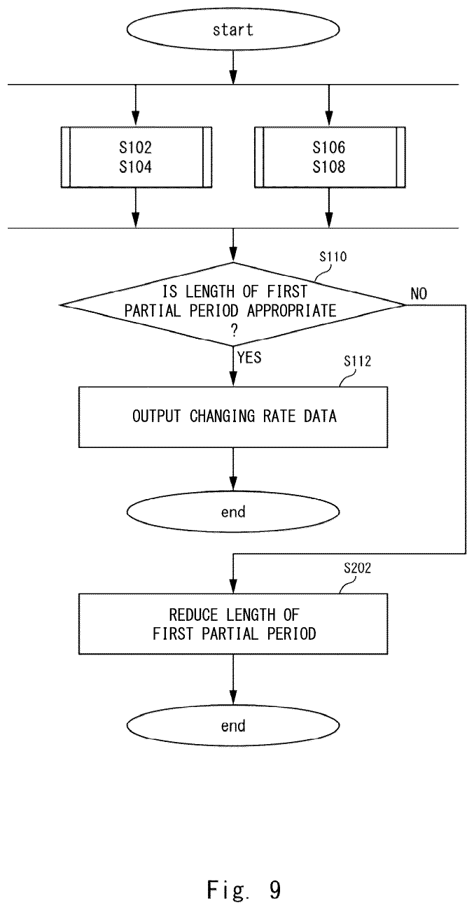

FIG. 9 is a second flowchart showing an example of a flow of processes performed by the state-of-polarization monitoring apparatus 2000. The processes shown in FIG. 9 are performed for each monitoring period. Steps S102 to S112 shown in FIG. 9 are the same as the steps S102 to S112, respectively, shown in FIG. 6. When it is determined that the length of the first partial period is not appropriate (S110: No), the changing unit 2100 reduces the length of the first partial period (S202).

Note that as described above, after the state-of-polarization monitoring apparatus 2000 changes the length of the first partial period in the process for a certain monitoring period, it may perform the process for that monitoring period again. In other words, the processes shown in FIG. 9 may be repeated until the length of the first partial period becomes appropriate.

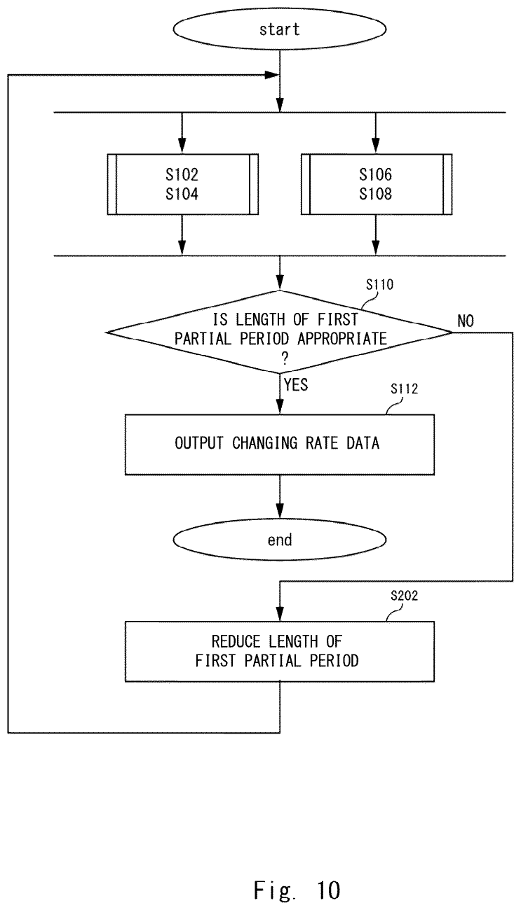

FIG. 10 is a third flowchart showing an example of a flow of processes performed by the state-of-polarization monitoring apparatus 2000. In the flowchart shown in FIG. 10, after a step S202 is performed, the process returns to the beginning of the flowchart and proceeds therefrom again. Therefore, the processes in the third flowchart are repeated for one monitoring period until the length of the first partial period becomes appropriate.

### Modified Example

As described above, instead of making the length of the first partial period longer than the length of the second partial period, the length of the interval between first partial periods may be made longer than the length of the interval between second partial periods. In this case, when it is determined that length of the interval between first partial periods is not appropriate, the changing unit 2100 reduces the length of the interval between first partial periods.

The method for reducing the length Q1 of the interval between first partial periods is the same as the method for reducing the length P1 of the first partial period. For example, the changing unit 2100 computes a new length of the interval between first partial periods by multiplying the length Q1 of the interval between first partial periods by the aforementioned constant d1.

### Third Example Embodiment

A state-of-polarization monitoring apparatus 2000 according to a third example embodiment performs a process of 1) outputting changing rate data without changing the length of the first partial period, 2) reducing the length of the first partial period, or 3) increasing the length of the first partial period. For this purpose, the state-of-polarization monitoring apparatus 2000 computes an SOP rotation angle not only for the first and second partial periods, but also for a third partial period whose length is longer than that of the first partial period.

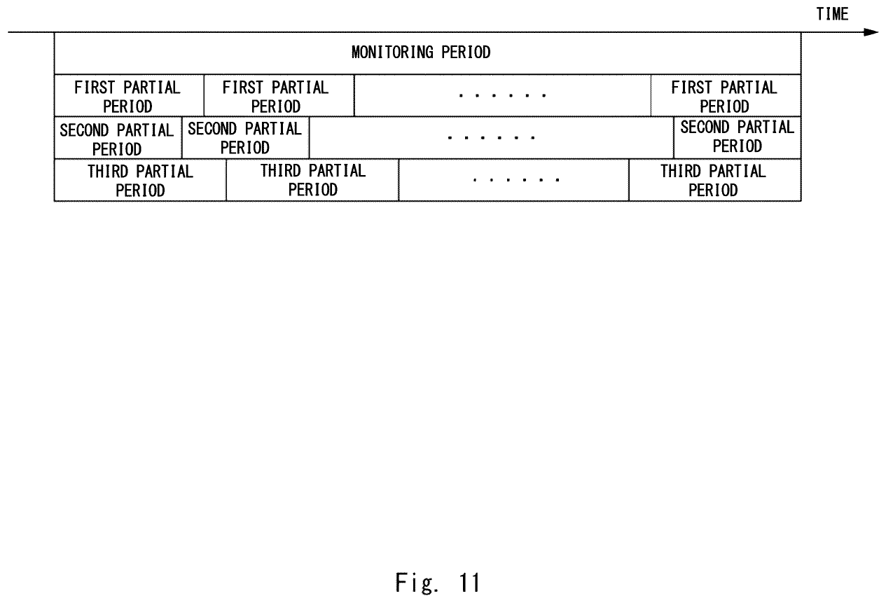

FIG. 11 shows an example of a first partial period, a second partial period, and a third partial period. As shown in FIG. 11, the third partial period is longer than the first partial period. Therefore, the first partial period is longer than the second partial period and shorter than the third partial period.

Specifically, the state-of-polarization monitoring apparatus 2000 operates as follows. The determining unit 2020 determines an SOP vector for each of a plurality of third partial periods obtained from the target monitoring period (S302). The length of the third partial period is represented by P3. Further, the number of third partial periods included in the target monitoring period is represented by L. When no interval is provided between third partial periods, L can be expressed as L=[P1/P3]. An SOP vector determined for a third partial period is referred to as a third SOP vector.

The length of the third partial period may be determined in advance or computed based on the length of the first partial period. In the latter case, for example, the state-of-polarization monitoring apparatus 2000 computes the length P3 of the third partial period by multiplying the length of the third partial period by a predetermined constant u1. That is, P3 can be expressed as P3=u1*P1. u1 is a real number larger than one. Alternatively, for example, the length P3 of the third partial period may be computed by adding a predetermined constant u2 to the length P1 of the first partial period (i.e., P3=P1+u2). u2 is a real number larger than zero.

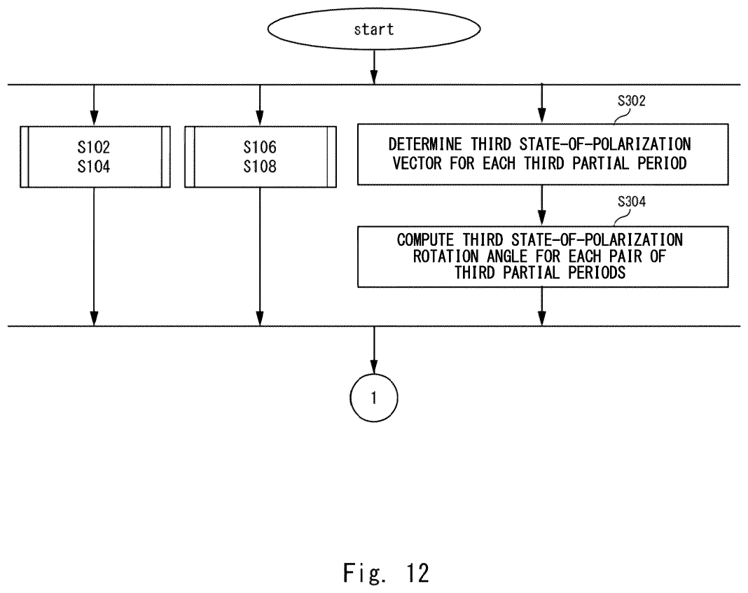

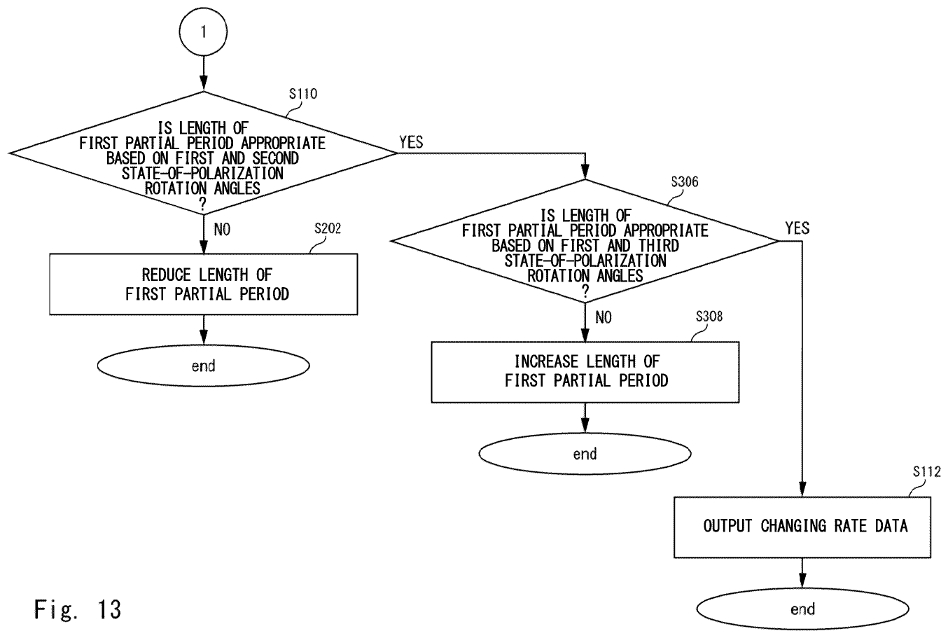

FIGS. 12 and 13 show a fourth flowchart showing an example of a flow of processes performed by the state-of-polarization monitoring apparatus 2000. In the flowchart shown in FIGS. 12 and 13, steps S102 to S112 are the same as the steps S102 to S112 in the flowchart shown in FIG. 6. In the flowchart shown in FIGS. 12 and 13, a step S202 is the same as the step S202 in the flowchart shown in FIG. 9.

The computing unit 2040 computes an SOP rotation angle for each of a plurality of pairs of third partial periods (S304). The SOP rotation angle computed for the third partial period is referred to as a third SOP rotation angle.

Both the process for computing a first SOP rotation angle (S102 and S104) and the process for computing a second SOP rotation angle (S106 and S108) are performed in the same manner as being performed in the first example embodiment.

The judging unit 2060 determines whether the length of the first partial period is appropriate or not based on the first and second SOP rotation angles (S110). In the step S110, when it is determined that the length of the first partial period is not appropriate (S110: No), the changing unit 2100 reduces the length of the first partial period (S202). Therefore, the determination in the step S110 can also be expressed as the “determination as to whether the length of the first partial period is longer than an appropriate length or not”.

In the step S110, when it is determined that the length of the first partial period is appropriate (S110: Yes), the judging unit 2060 determines whether the length of the first partial period is appropriate or not based on the first and third SOP rotation angles (S306). In the step S306, when it is determined that the length of the first partial period is not appropriate (S306: No), the changing unit 2100 increases the length of the first partial period (S308). Therefore, the determination in the step S306 can also be expressed as the “determination as to whether the length of the first partial period is shorter than an appropriate length or not”. Details of the steps S306 and S308 will be described later.

In the step S306, when it is determined that the length of the first partial period is appropriate (S306: Yes), the output unit 2080 outputs changing rate data (S112).

The flow of processes performed by the state-of-polarization monitoring apparatus 2000 is not limited to the flow shown in FIGS. 12 and 13. For example, the state-of-polarization monitoring apparatus 2000 may perform the step S110 after the step S306. In this case, when it is determined that the length of the first partial period is appropriate based on the first and third SOP rotation angles, the state-of-polarization monitoring apparatus 2000 determines whether the length of the first partial period is appropriate or not based on the first and second SOP rotation angles.

According to the state-of-polarization monitoring apparatus 2000 in accordance with the third example embodiment, when the length of the first partial period is longer than an appropriate length, the length of the first partial period is reduced. As a result, the length of the first partial period used in the subsequent monitoring periods is made closer to the appropriate length. Further, when the length of the first partial period is shorter than the appropriate length, the length of the first partial period is increased. As a result, the length of the first partial period used in the subsequent monitoring periods is also made closer to the appropriate length. Then, when the length of the first partial period is appropriate, changing rate data is output. Therefore, according to the state-of-polarization monitoring apparatus 2000, the length of the first partial period is adjusted in an adaptive manner, so that correct changing rate data is output for a larger number of monitoring periods.

The state-of-polarization monitoring apparatus 2000 may repeat, for each monitoring period, the process for that monitoring period until the length of the first partial period becomes appropriate. In this way, it is possible to compute correct changing rate data for all the monitoring periods.

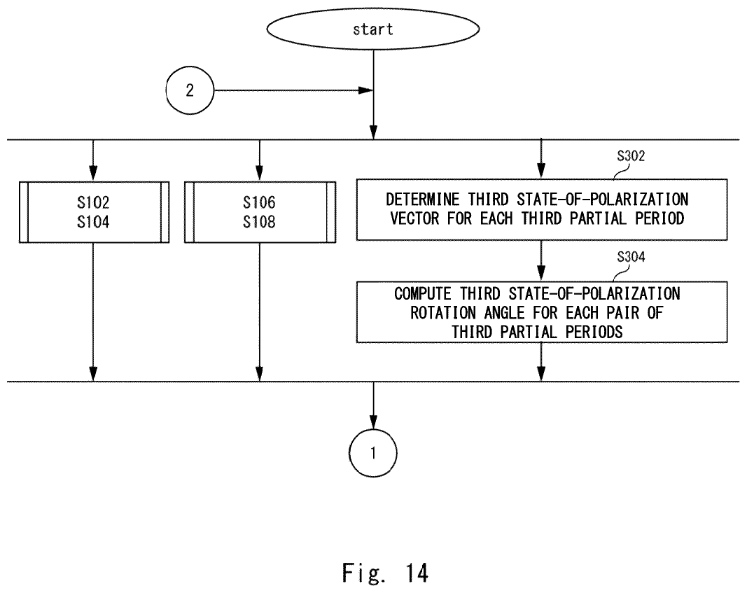

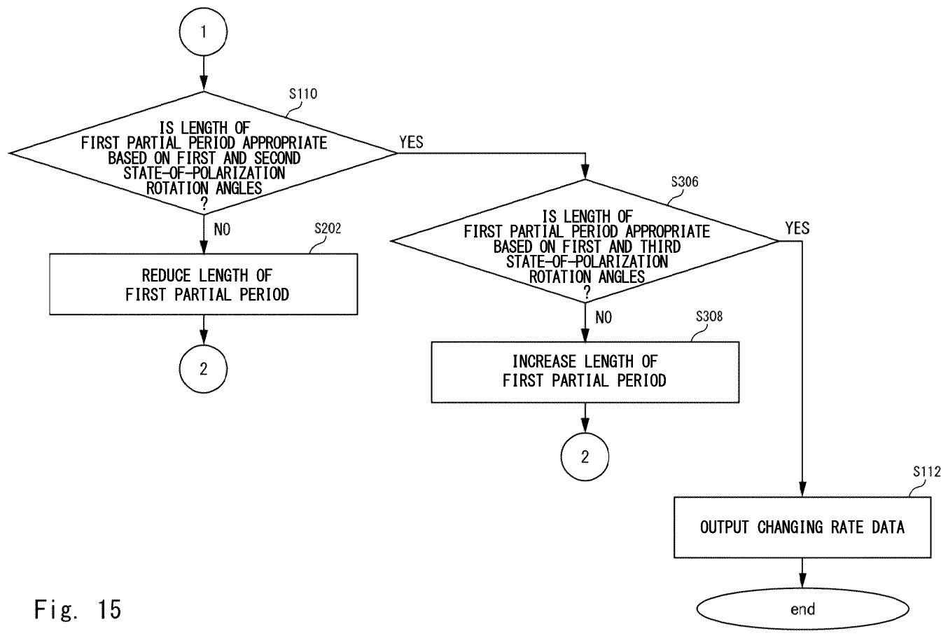

FIGS. 14 and 15 shows a fifth flowchart showing an example of a flow of processes performed by the state-of-polarization monitoring apparatus 2000. In the fifth flowchart, after the length of the first partial period is changed in a step S202 or S308, the process returns to the beginning of the flowchart and proceeds therefrom again. Therefore, in both the steps S110 and S306, the process for changing the length of the first partial period is repeated for one monitoring period until it is determined that the length of the first partial period is appropriate.

Note that in order to prevent the process from being looped endlessly, the amount of increase in the length of the first partial period in the step S308 is set to a value smaller than the amount of decrease in the length of the first partial period in the step S202.

### <Determination Using Third SOP Rotation Angle: S306>

The judging unit 2060 determines whether the length of the first partial period is appropriate or not based on the first and third SOP rotation angles (S306). Note that as long as the first and third SOP rotation angles have been correctly computed, the third SOP rotation angle is larger than the first SOP rotation angle in proportion to the length of the third partial period with respect to the length of the first partial period. However, when the first partial period is too short, the first SOP rotation angle cannot be correctly computed due to the influence of noise or the like, so that the above-described proportional relationship does not hold.

Therefore, for example, the judging unit 2060 determines whether the length of the first partial period is appropriate or not by determining whether or not the proportional relationship between the first and third SOP rotation angles correctly holds. For this purpose, for example, the judging unit 2060 computes an index value I2 defined by the following Equation (10).

$$\begin{matrix}[ Equation 10 ] & \\ {I}_{2} = \vert \frac{{P}_{3} * \frac{1}{N - 1} {\sum }_{i} {a}_{1} [ i ]}{{P}_{1} * \frac{1}{L - 1} {\sum }_{i} {a}_{3} [ i ]} - 1 \vert & ( 10 )\end{matrix}$$

P1 represents the length of the first partial period. P3 represents the length of the third partial period. N represents the number of first partial periods. L represents the number of third partial periods. a1[i] represents an i-th first SOP rotation angle. a3[i] represents an i-th third SOP rotation angle.

For example, the judging unit 2060 determines whether or not the index value I2 is equal to or larger than a predetermined threshold β. The threshold β satisfies a condition 0<β<1. When the index value I2 is equal to or larger than the threshold β, the judging unit 2060 determines that the length of the first partial period is appropriate (S306: Yes). On the other hand, when the index value I2 is smaller than the threshold β, the judging unit 2060 determines that the length of the first partial period is not appropriate (S306: No).

It is assumed that the value of the threshold β is determined in advance. The value of the threshold β may be arbitrarily determined. For example, the value of the threshold β can be determined by the same method as the method for determining the value of the threshold α.

### <Process for Increasing Length of First Partial Period: S308>

When it is determined that the length of the first partial period is not appropriate based on the first and third SOP rotation angles (S306: No), the changing unit 2100 increases the length of the first partial period (S308). There are various methods for increasing the length of the first partial period. For example, the changing unit 2100 uses a value obtained by multiplying the current length P1 of the first partial period by a predetermined number r1 (i.e., a value expressed as r1*P1) as a new length of the first partial period. r1 is a real number larger than one.

Alternatively, for example, the changing unit 2100 uses a value obtained by adding a predetermined constant r2 to the current length P1 of the first partial period (i.e., a value expressed as P1+2) as a new length of the first partial period. r2 is a real number larger than zero.

When the length of the first partial period is changed, the changing unit 2100 may change the lengths of the second and third partial periods according to the change in the length of the first partial period. For example, the changing unit 2100 uses a value obtained by multiplying the new length of the first partial period by a constant k1 as a new length of the second partial period. Similarly, the changing unit 2100 uses a value obtained by multiplying the new length of the first partial period by a constant u1 as a new length of the third partial period.

### Example of Functional Configuration

The functional configuration of the state-of-polarization monitoring apparatus 2000 according to the third example embodiment is, for example, shown in FIG. 8 as in the case of the functional configuration of the state-of-polarization monitoring apparatus 2000 according to the second example embodiment. However, the determining unit 2020 according to the third example embodiment determines, in addition to determining the first and second SOP vectors, a third SOP vector for each of a plurality of third partial periods obtained from the target monitoring period. Further, the computing unit 2040 computes, in addition to computing the first and second SOP rotation angles, a third SOP rotation angle for each of a plurality of pairs of third partial periods.

The judging unit 2060 determines whether the length of the first partial period is appropriate or not based on the first and second SOP rotation angles. Further, the judging unit 2060 determines whether the length of the first partial period is appropriate or not based on the first and third SOP rotation angles.

When it is determined that the length of the first partial period is appropriate based on the first and second SOP rotation angles, and it is determined that the length of the first partial period is appropriate based on the first and third SOP rotation angles, the output unit 2080 outputs changing rate data.

When it is determined that the length of the first partial period is not appropriate based on the first and second SOP rotation angles, the changing unit 2100 increases the length of the first partial period. Meanwhile, when it is determined that the length of the first partial period is not appropriate based on the first and third SOP rotation angles, the changing unit 2100 reduces the length of the first partial period.

### Example of Hardware Configuration

The state-of-polarization monitoring apparatus 2000 according to the third example embodiment has, for example, a hardware configuration shown in FIG. 5 as in the case of the state-of-polarization monitoring apparatuses 2000 according to the first and second example embodiments. However, a program(s) for implementing various functional components of the state-of-polarization monitoring apparatus 2000 according to the third example embodiment is stored in a storage device 1080 in the third example embodiment.

### Modified Example

Instead of making the lengths of the first, second, and third partial periods different from each other, the lengths of the interval between first partial periods, the interval between second partial periods, and the interval between third partial periods may be made different from each other. In this case, the judging unit 2060 determines whether the length of the interval between first partial periods is appropriate or not based on the first and second SOP rotation angles. Further, the judging unit 2060 determines whether the length of the interval between first partial periods is appropriate or not based on the first and third SOP rotation angles. The specific method for this determination is the same as the method for determining “whether the length of the first partial period is appropriate or not” described above.

For example, the judging unit 2060 computes an index value I1 based on the first and second SOP rotation angles, and determines whether or not the index value I1 is equal to or larger than a threshold α. When the index value I1 is larger than the threshold α (i.e., I1≥α), the judging unit 2060 determines that the length of the interval between first partial periods is appropriate. On the other hand, when the index value I1 is smaller than the threshold α (i.e., I1≥α), the judging unit 2060 determines that the length of the interval between first partial periods is not appropriate.

Similarly, the judging unit 2060 computes an index value I2 based on the first and third SOP rotation angles, and determines whether or not the index value I2 is equal to or larger than a threshold β. When the index value I2 is equal to or larger than the threshold β (i.e., I2≥β), the judging unit 2060 determines that the length of the interval between first partial periods is appropriate. On the other hand, the index value I2 is smaller than the threshold β (i.e., I2<β), the judging unit 2060 determines that the length of the interval between first partial periods is not appropriate.

When it is determined that the length of the interval between first partial periods is not appropriate based on the first and second SOP rotation angles, the changing unit 2100 reduces the length of the interval between first partial periods. The method for reducing the length Q1 of the interval between first partial periods is the same as the method described in the modified example of the second example embodiment.

When it is determined that the length of the interval between first partial periods is not appropriate based on the first and third SOP rotation angles, the changing unit 2100 increases the length of the interval between first partial periods. The method for increasing the length Q1 of the interval between first partial periods is the same as the method for increasing the length P1 of the first partial period. For example, the changing unit 2100 computes a new length of the interval between first partial periods by multiplying the length Q1 of the interval between first partial periods by the aforementioned constant d1.

According to the present disclosure, a new technique for monitoring the state of polarization of an optical reception signal is provided.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### (Supplementary Note 1)

A state-of-polarization monitoring apparatus comprising:
at least one memory that is configured store instructions; and
at least one processor that is configured to execute the instructions to:
determining, for each of a plurality of first partial periods obtained from a monitoring period, a first state-of-polarization vector that represents a state of polarization of an optical reception signal in the first partial period;
determining, for each of a plurality of second partial periods obtained from the monitoring period, a second state-of-polarization vector that represents a state of polarization of the optical reception signal in the second partial period; computing, for each of a plurality of pairs of first state-of-polarization vectors, a rotation angle of the first state-of-polarization vector;
computing, for each of a plurality of pairs of second state-of-polarization vectors, a rotation angle of the second state-of-polarization vector;
determining whether a length of the first partial period or a length of an interval between the first partial periods is appropriate or not based on the rotation angles of the first state-of-polarization vectors and the rotation angles of the second state-of-polarization vectors; and
outputting, when it is determined that the length of the first partial period or the length of the interval between the first partial periods is appropriate, changing rate data that represents a changing rate of the state of polarization in the monitoring period based on the rotation angle of the first state-of-polarization vector,
wherein a length of the second partial period is shorter than the length of the first partial period, or a length of an interval between the second partial periods is shorter than the length of the interval between the first partial periods.

### (Supplementary Note 2)

The state-of-polarization monitoring apparatus according to supplementary note 1,
wherein the at least one processor is configured to execute the instructions to determine that the length of the first partial period or the length of the interval between the first partial periods is appropriate when the rotation angles of the first state-of-polarization vectors are proportional to the rotation angles of the second state-of-polarization vectors.

### (Supplementary Note 3)

The state-of-polarization monitoring apparatus according to supplementary note 1,
wherein the at least one processor is configured to execute the instructions further to change the length of the first partial period when the length of the first partial period is not appropriate.

### (Supplementary Note 4)

The state-of-polarization monitoring apparatus according to supplementary note 3,
wherein the at least one processor is configured to execute the instructions further to:
determine, for each of a plurality of third partial periods obtained from the monitoring period, a third state-of-polarization vector that represents a state of polarization of the optical reception signal in the third partial period;
compute, for each of a plurality of pairs of third state-of-polarization vectors, a rotation angle of the third state-of-polarization vector;
determine whether the length of the first partial period or the length of the interval between first partial periods is appropriate or not based on the rotation angles of the first state-of-polarization vectors and the rotation angles of the third state-of-polarization vectors; and
output the changing rate data when it is determined that the length of the first partial period or the length of the interval between the first partial periods is appropriate based on the rotation angles of the first state-of-polarization vectors and the rotation angles of the second state-of-polarization vectors, and it is determined that the length of the first partial period or the length of the interval between first partial periods is appropriate based on the rotation angles of the first state-of-polarization vectors and the rotation angles of the third state-of-polarization vectors, and
wherein the length of the third partial period is longer than the length of the first partial period, or the length of the interval between the third partial periods is longer than the length of the interval between the first partial periods.

### (Supplementary Note 5)

The state-of-polarization monitoring apparatus according to supplementary note 4,
wherein the change of the length of the first partial period includes:
reducing the length of the first partial period when it is determined that the length of the first partial period is not appropriate based on the rotation angles of the first state-of-polarization vectors and the rotation angles of the second state-of-polarization vectors, or reducing the length of the interval between the first partial periods when it is determined that the length of the interval between the first partial periods is not appropriate based on the rotation angles of the first state-of-polarization vectors and the rotation angles of the second state-of-polarization vectors; and
increasing the length of the first partial period when it is determined that the length of the first partial period is not appropriate based on the rotation angles of the first state-of-polarization vectors and the rotation angles of the third state-of-polarization vectors, or increasing the length of the interval between the first partial periods when it is determined that the length of the interval between the first partial periods is not appropriate based on the rotation angles of the first state-of-polarization vectors and the rotation angles of the third state-of-polarization vectors.

### (Supplementary Note 6)

The state-of-polarization monitoring apparatus according to supplementary note 4,
wherein the at least one processor is configured to execute the instructions further to determine that the length of the first partial period or the length of the interval between the first partial periods is appropriate when the rotation angles of the first state-of-polarization vectors are proportional to the rotation angles of the third state-of-polarization vectors.

### (Supplementary Note 7)

A state-of-polarization monitoring method performed by a computer, the state-of-polarization monitoring method comprising:
determining, for each of a plurality of first partial periods obtained from a monitoring period, a first state-of-polarization vector that represents a state of polarization of an optical reception signal in the first partial period;
determining, for each of a plurality of second partial periods obtained from the monitoring period, a second state-of-polarization vector that represents a state of polarization of an optical reception signal in the second partial period;
computing, for each of a plurality of pairs of first state-of-polarization vectors, a rotation angle of the first state-of-polarization vector;
computing, for each of a plurality of pairs of second state-of-polarization vectors, a rotation angle of the second state-of-polarization vector;
determining whether a length of the first partial period or a length of an interval between first partial periods is appropriate or not based on the rotation angles of the first state-of-polarization vectors and the rotation angles of the second state-of-polarization vectors; and
outputting, when it is determined that the length of the first partial period or the length of the interval between the first partial periods is appropriate, changing rate data that represents a changing rate of the state of polarization in the monitoring period based on the rotation angle of the first state-of-polarization vector,
wherein a length of the second partial period is shorter than the length of the first partial period, or a length of an interval between the second partial periods is shorter than the length of the interval between the first partial periods.

### (Supplementary Note 8)

The state-of-polarization monitoring method according to supplementary note 7, further comprising determining that the length of the first partial period or the length of the interval between first partial periods is appropriate when the rotation angles of the first state-of-polarization vectors are proportional to the rotation angles of the second state-of-polarization vectors.

### (Supplementary Note 9)

The state-of-polarization monitoring method according to supplementary note 7, further comprising changing the length of the first partial period when the length of the first partial period is not appropriate.

### (Supplementary Note 10)

The state-of-polarization monitoring method according to supplementary note 9, further comprising:
determining, for each of a plurality of third partial periods obtained from the monitoring period, a third state-of-polarization vector that represents a state of polarization of the optical reception signal in the third partial period;
computing, for each of a plurality of pairs of third state-of-polarization vectors, a rotation angle of the third state-of-polarization vector;
determining whether the length of the first partial period or the length of the interval between first partial periods is appropriate or not based on the rotation angles of the first state-of-polarization vectors and the rotation angles of the third state-of-polarization vectors; and
outputting the changing rate data when it is determined that the length of the first partial period or the length of the interval between the first partial periods is appropriate based on the rotation angles of the first state-of-polarization vectors and the rotation angles of the second state-of-polarization vectors, and it is determined that the length of the first partial period or the length of the interval between the first partial periods is appropriate based on the rotation angles of the first state-of-polarization vectors and the rotation angles of the third state-of-polarization vectors,
wherein the length of the third partial period is longer than the length of the first partial period, or the length of the interval between the third partial periods is longer than the length of the interval between the first partial periods.

### (Supplementary Note 11)

The state-of-polarization monitoring method according to supplementary note 10,
wherein the change of the length of the first partial period includes:
reducing the length of the first partial period when it is determined that the length of the first partial period is not appropriate based on the rotation angles of the first state-of-polarization vectors and the rotation angles of the second state-of-polarization vectors, or reducing the length of the interval between the first partial periods when it is determined that the length of the interval between the first partial periods is not appropriate based on the rotation angles of the first state-of-polarization vectors and the rotation angles of the second state-of-polarization vectors, and
increasing the length of the first partial period when it is determined that the length of the first partial period is not appropriate based on the rotation angles of the first state-of-polarization vectors and the rotation angles of the third state-of-polarization vectors, or increasing the length of the interval between the first partial periods when it is determined that the length of the interval between the first partial periods is not appropriate based on the rotation angles of the first state-of-polarization vectors and the rotation angles of the third state-of-polarization vectors.

### (Supplementary Note 12)

The state-of-polarization monitoring method according to supplementary note 10, further comprising determining that the length of the first partial period or the length of the interval between the first partial periods is appropriate when the rotation angles of the first state-of-polarization vectors are proportional to the rotation angles of the third state-of-polarization vectors.

### (Supplementary Note 13)

A non-transitory computer-readable medium storing a program that causes a computer to execute:
determining, for each of a plurality of first partial periods obtained from a monitoring period, a first state-of-polarization vector that represents a state of polarization of an optical reception signal in the first partial period;
determining, for each of a plurality of second partial periods obtained from the monitoring period, a second state-of-polarization vector that represents a state of polarization of an optical reception signal in the second partial period;
computing, for each of a plurality of pairs of first state-of-polarization vectors, a rotation angle of the first state-of-polarization vector;
computing, for each of a plurality of pairs of second state-of-polarization vectors, a rotation angle of the second state-of-polarization vector;
determining whether a length of the first partial period or a length of an interval between first partial periods is appropriate or not based on the rotation angles of the first state-of-polarization vectors and the rotation angles of the second state-of-polarization vectors; and
outputting, when it is determined that the length of the first partial period or the length of the interval between the first partial periods is appropriate, changing rate data that represents a changing rate of the state of polarization in the monitoring period based on the rotation angle of the first state-of-polarization vector,
wherein a length of the second partial period is shorter than the length of the first partial period, or a length of an interval between the second partial periods is shorter than the length of the interval between the first partial periods.

### (Supplementary Note 14)

The medium according to supplementary note 13,
wherein the program causes the compute to further execute determining that the length of the first partial period or the length of the interval between first partial periods is appropriate when the rotation angles of the first state-of-polarization vectors are proportional to the rotation angles of the second state-of-polarization vectors.

### (Supplementary Note 15)

The medium according to supplementary note 13,
wherein the program causes the computer to further execute changing the length of the first partial period when the length of the first partial period is not appropriate.

### (Supplementary Note 16)

The medium according to supplementary note 15,
wherein the program causes the computer to further execute:
determining, for each of a plurality of third partial periods obtained from the monitoring period, a third state-of-polarization vector that represents a state of polarization of the optical reception signal in the third partial period;
computing, for each of a plurality of pairs of third state-of-polarization vectors, a rotation angle of the third state-of-polarization vector;
determining whether the length of the first partial period or the length of the interval between first partial periods is appropriate or not based on the rotation angles of the first state-of-polarization vectors and the rotation angles of the third state-of-polarization vectors; and
outputting the changing rate data when it is determined that the length of the first partial period or the length of the interval between the first partial periods is appropriate based on the rotation angles of the first state-of-polarization vectors and the rotation angles of the second state-of-polarization vectors, and it is determined that the length of the first partial period or the length of the interval between the first partial periods is appropriate based on the rotation angles of the first state-of-polarization vectors and the rotation angles of the third state-of-polarization vectors, and
wherein the length of the third partial period is longer than the length of the first partial period, or the length of the interval between the third partial periods is longer than the length of the interval between the first partial periods.

### (Supplementary Note 17)

The medium according to supplementary note 16,
wherein the change of the length of the first partial period includes:
reducing the length of the first partial period when it is determined that the length of the first partial period is not appropriate based on the rotation angles of the first state-of-polarization vectors and the rotation angles of the second state-of-polarization vectors, or reducing the length of the interval between the first partial periods when it is determined that the length of the interval between the first partial periods is not appropriate based on the rotation angles of the first state-of-polarization vectors and the rotation angles of the second state-of-polarization vectors, and
increasing the length of the first partial period when it is determined that the length of the first partial period is not appropriate based on the rotation angles of the first state-of-polarization vectors and the rotation angles of the third state-of-polarization vectors, or increasing the length of the interval between the first partial periods when it is determined that the length of the interval between the first partial periods is not appropriate based on the rotation angles of the first state-of-polarization vectors and the rotation angles of the third state-of-polarization vectors.

### (Supplementary Note 18)

The medium according to supplementary note 16,
wherein the program causes the computer to further execute determining that the length of the first partial period or the length of the interval between the first partial periods is appropriate when the rotation angles of the first state-of-polarization vectors are proportional to the rotation angles of the third state-of-polarization vectors.

What is claimed is:

1. A state-of-polarization monitoring apparatus comprising:
at least one memory that is configured store instructions; and
at least one processor that is configured to execute the instructions to:
determining, for each of a plurality of first partial periods obtained from a monitoring period, a first state-of-polarization vector that represents a state of polarization of an optical reception signal in the first partial period;
determining, for each of a plurality of second partial periods obtained from the monitoring period, a second state-of-polarization vector that represents a state of polarization of the optical reception signal in the second partial period; computing, for each of a plurality of pairs of first state-of-polarization vectors, a rotation angle of the first state-of-polarization vector;
computing, for each of a plurality of pairs of second state-of-polarization vectors, a rotation angle of the second state-of-polarization vector;
determining whether a length of the first partial period or a length of an interval between the first partial periods is appropriate or not based on the rotation angles of the first state-of-polarization vectors and the rotation angles of the second state-of-polarization vectors; and
outputting, when it is determined that the length of the first partial period or the length of the interval between the first partial periods is appropriate, changing rate data that represents a changing rate of the state of polarization in the monitoring period based on the rotation angle of the first state-of-polarization vector,
wherein a length of the second partial period is shorter than the length of the first partial period, or a length of an interval between the second partial periods is shorter than the length of the interval between the first partial periods.

2. The state-of-polarization monitoring apparatus according to claim 1,
wherein the at least one processor is configured to execute the instructions to determine that the length of the first partial period or the length of the interval between the first partial periods is appropriate when the rotation angles of the first state-of-polarization vectors are proportional to the rotation angles of the second state-of-polarization vectors.

3. The state-of-polarization monitoring apparatus according to claim 1,
wherein the at least one processor is configured to execute the instructions further to change the length of the first partial period when the length of the first partial period is not appropriate.

4. The state-of-polarization monitoring apparatus according to claim 3,
wherein the at least one processor is configured to execute the instructions further to:
determine, for each of a plurality of third partial periods obtained from the monitoring period, a third state-of-polarization vector that represents a state of polarization of the optical reception signal in the third partial period;
compute, for each of a plurality of pairs of third state-of-polarization vectors, a rotation angle of the third state-of-polarization vector;
determine whether the length of the first partial period or the length of the interval between first partial periods is appropriate or not based on the rotation angles of the first state-of-polarization vectors and the rotation angles of the third state-of-polarization vectors; and
output the changing rate data when it is determined that the length of the first partial period or the length of the interval between the first partial periods is appropriate based on the rotation angles of the first state-of-polarization vectors and the rotation angles of the second state-of-polarization vectors, and it is determined that the length of the first partial period or the length of the interval between first partial periods is appropriate based on the rotation angles of the first state-of-polarization vectors and the rotation angles of the third state-of-polarization vectors, and
wherein the length of the third partial period is longer than the length of the first partial period, or the length of the interval between the third partial periods is longer than the length of the interval between the first partial periods.

5. The state-of-polarization monitoring apparatus according to claim 4,
wherein the change of the length of the first partial period includes:
reducing the length of the first partial period when it is determined that the length of the first partial period is not appropriate based on the rotation angles of the first state-of-polarization vectors and the rotation angles of the second state-of-polarization vectors, or reducing the length of the interval between the first partial periods when it is determined that the length of the interval between the first partial periods is not appropriate based on the rotation angles of the first state-of-polarization vectors and the rotation angles of the second state-of-polarization vectors; and
increasing the length of the first partial period when it is determined that the length of the first partial period is not appropriate based on the rotation angles of the first state-of-polarization vectors and the rotation angles of the third state-of-polarization vectors, or increasing the length of the interval between the first partial periods when it is determined that the length of the interval between the first partial periods is not appropriate based on the rotation angles of the first state-of-polarization vectors and the rotation angles of the third state-of-polarization vectors.

6. The state-of-polarization monitoring apparatus according to claim 4,
wherein the at least one processor is configured to execute the instructions further to determine that the length of the first partial period or the length of the interval between the first partial periods is appropriate when the rotation angles of the first state-of-polarization vectors are proportional to the rotation angles of the third state-of-polarization vectors.

7. A state-of-polarization monitoring method performed by a computer, the state-of-polarization monitoring method comprising:
determining, for each of a plurality of first partial periods obtained from a monitoring period, a first state-of-polarization vector that represents a state of polarization of an optical reception signal in the first partial period;
determining, for each of a plurality of second partial periods obtained from the monitoring period, a second state-of-polarization vector that represents a state of polarization of an optical reception signal in the second partial period;
computing, for each of a plurality of pairs of first state-of-polarization vectors, a rotation angle of the first state-of-polarization vector;
computing, for each of a plurality of pairs of second state-of-polarization vectors, a rotation angle of the second state-of-polarization vector;
determining whether a length of the first partial period or a length of an interval between first partial periods is appropriate or not based on the rotation angles of the first state-of-polarization vectors and the rotation angles of the second state-of-polarization vectors; and
outputting, when it is determined that the length of the first partial period or the length of the interval between the first partial periods is appropriate, changing rate data that represents a changing rate of the state of polarization in the monitoring period based on the rotation angle of the first state-of-polarization vector,
wherein a length of the second partial period is shorter than the length of the first partial period, or a length of an interval between the second partial periods is shorter than the length of the interval between the first partial periods.

8. The state-of-polarization monitoring method according to claim 7, further comprising determining that the length of the first partial period or the length of the interval between first partial periods is appropriate when the rotation angles of the first state-of-polarization vectors are proportional to the rotation angles of the second state-of-polarization vectors.

9. The state-of-polarization monitoring method according to claim 7, further comprising changing the length of the first partial period when the length of the first partial period is not appropriate.

10. The state-of-polarization monitoring method according to claim 9, further comprising:
determining, for each of a plurality of third partial periods obtained from the monitoring period, a third state-of-polarization vector that represents a state of polarization of the optical reception signal in the third partial period;
computing, for each of a plurality of pairs of third state-of-polarization vectors, a rotation angle of the third state-of-polarization vector;
determining whether the length of the first partial period or the length of the interval between first partial periods is appropriate or not based on the rotation angles of the first state-of-polarization vectors and the rotation angles of the third state-of-polarization vectors; and
outputting the changing rate data when it is determined that the length of the first partial period or the length of the interval between the first partial periods is appropriate based on the rotation angles of the first state-of-polarization vectors and the rotation angles of the second state-of-polarization vectors, and it is determined that the length of the first partial period or the length of the interval between the first partial periods is appropriate based on the rotation angles of the first state-of-polarization vectors and the rotation angles of the third state-of-polarization vectors,
wherein the length of the third partial period is longer than the length of the first partial period, or the length of the interval between the third partial periods is longer than the length of the interval between the first partial periods.

11. The state-of-polarization monitoring method according to claim 10,
wherein the change of the length of the first partial period includes:
reducing the length of the first partial period when it is determined that the length of the first partial period is not appropriate based on the rotation angles of the first state-of-polarization vectors and the rotation angles of the second state-of-polarization vectors, or reducing the length of the interval between the first partial periods when it is determined that the length of the interval between the first partial periods is not appropriate based on the rotation angles of the first state-of-polarization vectors and the rotation angles of the second state-of-polarization vectors, and
increasing the length of the first partial period when it is determined that the length of the first partial period is not appropriate based on the rotation angles of the first state-of-polarization vectors and the rotation angles of the third state-of-polarization vectors, or increasing the length of the interval between the first partial periods when it is determined that the length of the interval between the first partial periods is not appropriate based on the rotation angles of the first state-of-polarization vectors and the rotation angles of the third state-of-polarization vectors.

12. The state-of-polarization monitoring method according to claim 10, further comprising determining that the length of the first partial period or the length of the interval between the first partial periods is appropriate when the rotation angles of the first state-of-polarization vectors are proportional to the rotation angles of the third state-of-polarization vectors.

13. A non-transitory computer-readable medium storing a program that causes a computer to execute:
determining, for each of a plurality of first partial periods obtained from a monitoring period, a first state-of-polarization vector that represents a state of polarization of an optical reception signal in the first partial period;
determining, for each of a plurality of second partial periods obtained from the monitoring period, a second state-of-polarization vector that represents a state of polarization of an optical reception signal in the second partial period;
computing, for each of a plurality of pairs of first state-of-polarization vectors, a rotation angle of the first state-of-polarization vector;
computing, for each of a plurality of pairs of second state-of-polarization vectors, a rotation angle of the second state-of-polarization vector;
determining whether a length of the first partial period or a length of an interval between first partial periods is appropriate or not based on the rotation angles of the first state-of-polarization vectors and the rotation angles of the second state-of-polarization vectors; and
outputting, when it is determined that the length of the first partial period or the length of the interval between the first partial periods is appropriate, changing rate data that represents a changing rate of the state of polarization in the monitoring period based on the rotation angle of the first state-of-polarization vector,
wherein a length of the second partial period is shorter than the length of the first partial period, or a length of an interval between the second partial periods is shorter than the length of the interval between the first partial periods.

14. The medium according to claim 13,
wherein the program causes the compute to further execute determining that the length of the first partial period or the length of the interval between first partial periods is appropriate when the rotation angles of the first state-of-polarization vectors are proportional to the rotation angles of the second state-of-polarization vectors.

15. The medium according to claim 13,
wherein the program causes the computer to further execute changing the length of the first partial period when the length of the first partial period is not appropriate.

16. The medium according to claim 15,
wherein the program causes the computer to further execute:
determining, for each of a plurality of third partial periods obtained from the monitoring period, a third state-of-polarization vector that represents a state of polarization of the optical reception signal in the third partial period;
computing, for each of a plurality of pairs of third state-of-polarization vectors, a rotation angle of the third state-of-polarization vector;
determining whether the length of the first partial period or the length of the interval between first partial periods is appropriate or not based on the rotation angles of the first state-of-polarization vectors and the rotation angles of the third state-of-polarization vectors; and
outputting the changing rate data when it is determined that the length of the first partial period or the length of the interval between the first partial periods is appropriate based on the rotation angles of the first state-of-polarization vectors and the rotation angles of the second state-of-polarization vectors, and it is determined that the length of the first partial period or the length of the interval between the first partial periods is appropriate based on the rotation angles of the first state-of-polarization vectors and the rotation angles of the third state-of-polarization vectors, and
wherein the length of the third partial period is longer than the length of the first partial period, or the length of the interval between the third partial periods is longer than the length of the interval between the first partial periods.

17. The medium according to claim 16,
wherein the change of the length of the first partial period includes:
reducing the length of the first partial period when it is determined that the length of the first partial period is not appropriate based on the rotation angles of the first state-of-polarization vectors and the rotation angles of the second state-of-polarization vectors, or reducing the length of the interval between the first partial periods when it is determined that the length of the interval between the first partial periods is not appropriate based on the rotation angles of the first state-of-polarization vectors and the rotation angles of the second state-of-polarization vectors, and
increasing the length of the first partial period when it is determined that the length of the first partial period is not appropriate based on the rotation angles of the first state-of-polarization vectors and the rotation angles of the third state-of-polarization vectors, or increasing the length of the interval between the first partial periods when it is determined that the length of the interval between the first partial periods is not appropriate based on the rotation angles of the first state-of-polarization vectors and the rotation angles of the third state-of-polarization vectors.

18. The medium according to claim 16,
wherein the program causes the computer to further execute determining that the length of the first partial period or the length of the interval between the first partial periods is appropriate when the rotation angles of the first state-of-polarization vectors are proportional to the rotation angles of the third state-of-polarization vectors.
